(19) United States
(12) Patent Application Publication
(10) Pub. No.: US 2020/0027266 A1
(43) Pub. Date: Jan. 23, 2020

(54) BUILDING CONTOUR GENERATION FROM POINT CLOUDS

(71) Applicant: UTI LIMITED PARTNERSHIP, Calgary (CA)

(72) Inventors: Dong CHEN, Nanjing (CN); Ruisheng WANG, Calgary (CA)

(21) Appl. No.: 16/513,086

(22) Filed: Jul. 16, 2019

Related U.S. Application Data
(60) Provisional application No. 62/699,277, filed on Jul. 17, 2018.

(51) Int. Cl. G06T 17/05; G06T 17/10; G06K 9/00; G06T 7/13; G06K 9/72

(52) U.S. Cl. CPC G06T 17/05; G06T 17/10; G06K 9/00201; G06T 2207/10028; G06K 9/726; G06T 2207/20072; G06T 7/13

(57) ABSTRACT

Systems and methods for generating building contours from point cloud data. The point cloud data is analyzed to identify one or more buildings. The contours of these buildings are then determined and these contours are decomposed into linear primitives. The results are then regularized and the final contours are generated from these regularized primitives. The contours can then be used in visualizations of building models.

### RELATED APPLICATIONS

This application is a non-provisional patent application which claims the benefit of U.S. Provisional Application No. 62/699,277 filed on Jul. 17, 2018.

### TECHNICAL FIELD

The present invention generally relates to geomatics and survey engineering. More specifically, the present invention relates to systems and methods for producing contours or images of buildings from point clouds obtained by various means of scanning.

### BACKGROUND

Building roof contour extraction from airborne laser scanning (ALS) point clouds is of paramount importance for many applications such as urban scene modeling [5, 38], cadastral mapping [8], 3D visualization and generalization [21], building abstraction [41, 34] and outdoor navigation [7]. In urban reconstruction, the accuracy of the 3D building models heavily relies on the building contours extracted during the initial stages of the pipeline. For example, for multi-view aerial imagery construction, the rectilinear building contours can be matched to corresponding shapes (from other views) for stereo reconstruction [47]. For ALS-based reconstruction, precise positioning of rooftop contours is a crucial step towards the accurate LoD1 facade modeling due to insufficient facade point clouds [37]. In addition, the regular shapes of rooftop contours are also considered as an important prerequisite for the production of visually photorealistic building models from outer and/or inner rooftop contours.

Historically, a plethora of methods in different domains have been proposed for building contouring. These will be reviewed below. It would be convenient to classify these previously proposed methods according to the most important characteristics of building contouring results as follows: a) Geometry-based contouring; b) Topology-based contouring; and c) Regularity-based contouring.

### Geometry-Based Contouring

This group of methods primarily considers the factor of geometric accuracy for generating building contours and makes the created contours exact or very close to the building shapes. When this approach was first proposed many years ago, the traditional Canny [3], Roberts [27], Sobel [28], Prewitt [26] and mathematical morphology [30] operators were intensively used for object contour extraction from imagery. However, although the imagery contouring algorithm is simple and efficient, it suffers from occlusions, low contrast, and unfavorable perspectives. In more recent works, Poullis [25] uses the contouring algorithm [33] to trace a set of exterior boundaries corresponding to each planar primitive from the raster images derived from point clouds. However, the conversion of point clouds into raster images often results in inappropriate selection of image resolution, thereby reducing the precision. To overcome the drawbacks of image-based contouring algorithms, other computational geometry algorithms, such as convex hull, alpha shapes, Delaunay based sculpting algorithms as well as their variations, have been frequently used in the past to approximate the object contours from the point clouds. For example, the convex hull [9] can only generate convex shapes and, in this sense, it is not capable of identifying the concavities and the possible holes inside some shapes. To deal with such problems, convex hull's variational approaches [15, 29] have been developed to trace building contours for both convex and concave shapes. Alpha shapes [11] can trace arbitrary building shapes with proper outer and/or inner contours (holes). However, the topological relationships among contour points (edges), i.e., the sequence of contour points in clockwise or counter-clockwise orders cannot be captured. Moreover, traced contours typically contain far too many details, as well as noise and outliers. As such, they do not comply with the compact representation of building contours. In another approach, Verma et al. [35] have applied the 2D ball-pivoting algorithm to triangulate building points and delineate an approximate building rooftop contours. However, in their method, when the point density is low, some of contour segments will not be created, leaving unclosed topology. In addition, when curvature of the manifold is larger than 1/y, where y is the input parameter of 2D ball-pivoting algorithm, representing a circle of ball radius, some of the points will not be reached by the pivoting ball, and contour features will be missed. Peethambaran and Muthuganapathy [24] have proposed a Delaunay based sculpting algorithm for approximating 2D shapes from point clouds. Since this method is non-parametric, the advantage of this method is that it avoids the tedious work of tuning parameters.

### Topology-Based Contouring

This class of algorithms focus on methodologies which generate building contours with correct topologies, for example the sequence relationships among contour points, closure of each contour, without self-intersection for individual contour entity, without intersection among different contour entities, and inclusion relationships, etc. To this end, Zhou and Neumann [45] have proposed a heuristic algorithm for tracing rooftop primitives based on uniform grid. Although this algorithm is robust and guarantees topological correctness, the input points may reside outside the extracted contours, resulting in incomplete geometry. To restore the topology of building contours, Wang and Shan [36] have proposed the combination of the convex hull with minimum spanning tree (MST) to establish building contour topology via a depth-first searching on MST. Similarly, Chen et al. [6] have considered the combination of alpha shapes and MST to restore the topological relationships, through which the maximum closed loops as building contours are discovered via solving an optimization problem. Based on a Delaunay triangulation data structure, Chen et al. [5] have interpolated the shared segments among planar primitives as rooftop primitives' contours to produce the seamless rooftop contouring representation. In [1], Awrangjeb has proposed a method for identifying the building contours by analyzing the neighboring relationships of triangles and restoring the topology among contour points via searching the potential loops from the tree structure.

### Regularity-Based Contouring

The previously mentioned two categories of methods aim at producing building contours with accurate geometry and correct topology. However, regularity-based contouring methods aim at generating light-weight and regular building contour shapes. In other words, the generated building contours need to comply with the compact representation and visual regularity through explicitly or implicitly imposing a series of priors. For this, Zhang et al. [44] first considered the Douglas-Peucker algorithm [10] to simplify the contours, followed by the regularization of simplified edges via defining a series of rules. However, the main disadvantage of their method is that it requires too many hard constraints, thus restricting the scalability of the proposed algorithm. In another approach, Li et al. [18] have eliminated the zigzag artifacts of roof contours by first aligning the projected 2D grid with the building dominants and then using the Douglas-Peucker algorithm to further simplify rooftop contours. Although the Douglas-Peucker algorithm can eliminate the redundant contour points to maintain the compact contour representation, it might result in some topological errors, e.g., self-intersection, which undermines the originally established contour's topology.

In an effort to make building contours aligned with the building's dominant directions, a robust method for rooftop contour reconstruction was proposed in Zhou and Neumann [45], where multiple dominant directions have been determined through statistical analysis of contour points' tangent directions in local areas. Yang et al. [42] proposed a method to determine the facade's footprint from mobile laser scanning (MLS) point clouds by principal component analysis of a facade's dominant directions. Cheng et al. [4] have used the Hough transform under the constraints of principal directions derived from the point clouds to obtain more meaningful building contours from imagery. Sampath and Shan [29] have proposed a hierarchical least squares solution with orthogonality constraints to determine regularized rectangular contours. However, this method is restricted in dealing with buildings having only two dominant directions. As such, it cannot deal with more buildings having more complex structures, e.g., building containing inner yards and non-linear parts. Awrangjeb [1] has integrated identification, tracing and regularization into a unified framework to generate rectilinear building contours. Performance results have shown that contour identification and tracing steps are robust and can process arbitrary building shapes. However, the regularization step needs numerous hard constraints and the extracted contours very much depend on the principal dominants.

Explicit imposition of hard constraints on building contours has its own limitations for capturing the descriptions of complex building shapes as such shapes lack adequate characteristics that can be defined by a series of hard constraints. Having the regularity process implicitly embedded in energy optimization provides a flexible way to delineate more complex building contours. A series of publications along this line have demonstrated the effectiveness of these implicit soft constraints. For example, the optimization based on the snake model is commonly used for extracting building roof contours from images [13] and refining 2D topology of rooftop contours [43]. Marked point process is used to provide rectangular building contours in [17]. In [25], the rooftop contour's orientations are determined by coupling the strengths of Gaussian mixture model (GMM) and the efficient energy minimization via graph cuts. In another method, the minimum description length (MDL) optimization is used to derive the regularized rooftop topology [32] and building contours [16] through integrating a series of implicit hypothesis rules. Zhou and Neumann [46] have proposed a framework of rooftop reconstruction by introducing a variety of global regularities, including roof-roof regularity, roof-boundary regularity, and boundary-boundary regularity. The principle of this method is that global regularity reveals the primitives' topological relationships and similarities for intrinsic structure of building models arising from architectural designs.

All-in-all, the previously mentioned three categories of methods mainly consider contouring from single particular aspect, such as accurate geometry, correct topology, compactness abstraction, or visual regularity to meet specific applications. These and other methods are unsuitable for processing large-scale residential scenes. There is therefore a need for systems and devices that mitigate if not overcome the limitations of the prior art.

### SUMMARY

The present invention provides systems and methods for generating building contours from point cloud data. The point cloud data is analyzed to identify one or more buildings. The contours of these buildings are then determined and these contours are decomposed into linear primitives. The results are then regularized and the final contours are generated from these regularized primitives. The contours can then be used in visualizations of building models.

In a first aspect, the present invention provides a method for generating building contours from point cloud data, the method comprising:
a) identifying at least one building from said point cloud data;
b) determining contours of said at least one building from said point cloud data;
c) decomposing contours determined in step b);
d) regularizing said contours to result in regularized contours; and
e) generating final contours from said regularized contours.

In a second aspect, the present invention provides computer readable media having encoded thereon computer readable and computer executable instructions that, when executed, implements a method for generating building contours from point cloud data, the method comprising:
a) identifying at least one building from said point cloud data;
b) determining contours of said at least one building from said point cloud data;
c) decomposing contours determined in step b);
d) regularizing said contours to result in regularized contours; and
e) generating final contours from said regularized contours.

In a third aspect, the present invention provides a system for generating building contours from point cloud data, the system comprising:
a building identification module for identifying at least one building from said point cloud data;
a contour determination module for determining contours of said at least one building from said point cloud data;
a contour decomposition module for decomposing contours determined by said contour determination module;
a contour regularization module for regularizing said contours to result in regularized contours; and
a contour generation module for generating final contours from said regularized contours.

### BRIEF DESCRIPTION OF THE DRAWINGS

The embodiments of the present invention will now be described by reference to the following figures, in which identical reference numerals in different figures indicate identical elements and in which:

FIG. 1 is a diagram illustrating an overview of a method according to one aspect of the present invention.

FIGS. 2A-2B show instance level segments. In FIG. 2A, DBSCAN segments are shown and different colors represent individual buildings under the condition that disjoint buildings may share the same color. In FIG. 2B, enhanced DBSCAN segments are shown where individual buildings are illustrated by bounding boxes.

FIGS. 3A-3C show topologically-aware propagation in different directions. FIG. 3A shows building contour propagation in a clockwise sequence while FIG. 3B shows building contour propagation in a counter clockwise sequence. FIG. 3C shows the initial building contour denoted by a red color as well as a legend for FIGS. 3A-3B.

FIGS. 4A-4B show the results of linear primitive extraction before and after optimized decomposition. FIG. 4A shows the results using RANSAC while FIG. 4B shows the optimized decomposition results after applying the invention. It should be noted that the collinear but separated linear primitives are identified as multiple linear primitives based on the principle of continuity. The different colors represent the distinct linear primitives under the condition that the disjoint linear primitives may share the same color.

FIG. 5A shows a shaded relief map of Site 1 with a lot of small-sized single-family houses.

FIG. 5B shows a shaded relief map of Site 2 with buildings with varied sizes and shapes.

FIG. 5C shows a shaded relief map of Site 3 corrupted by a large degree of missing data.

FIGS. 6A-6F illustrate the generation of building contours from typical buildings with different levels of missing data. In the left-most image, the raw point clouds are colored by elevation. In the right-most image, the reconstructed LoD1 models are shown by using building contours. The middle images show the created building contours rendered in 2D and 3D.

FIGS. 7A-7D illustrate the building of contours by exploring global structural patterns where, in the left-most image, the created building contours are overlaid on their point clouds. The building contours are triangulated in the middle image and in the right-most image, the building contours are modeled.

FIG. 8 shows the generation of building contouring of complex geometrical shapes via hybrid representation. The subfigures represent some typical complex geometry shapes which were selected to evaluate the adaptability of the present invention.

FIG. 9A-9D show the results if missing data causes an unclosed contour. FIG. 9A shows the point clouds colored by elevation while FIG. 9B shows the corresponding Google™ street view image. FIGS. 9C and 9D show the initial building contours and part of its enlarged view.

FIGS. 10A-10B show the inclusion relationship of multiple contours within a complex. In FIG. 10A, the initial building contours are shown (left image) along with the contour decomposition (middle image). The created contours rendered in 2D are shown in the right image in FIG. 10A. The created contours rendered in 3D are shown in the left image of FIG. 10B. The middle image in FIG. 10B shows the LoD1 surface model while the right image in FIG. 10B shows the LoD1 mesh model.

FIG. 11 shows building contour representations at different LoDs. The left-most image shows an overlay of the initial building contour onto the point clouds. Three levels of contour abstractions by tuning different parameters are shown in the rest of the images.

FIG. 12A-12C show building contour results for Sites 1-3;

FIG. 13 shows the LoD1 modeling of Sites 1-3 from the constructed contours; and

FIG. 14 is a block diagram of a system according to one aspect of the present invention.

### DETAILED DESCRIPTION

To better understand the present invention, the reader is directed to the listing of citations at the end of this description. For ease of reference, these citations and references have been referred to by their listing number throughout this document. The contents of the citations in the list at the end of this description are hereby incorporated by reference herein in their entirety.

The present invention focuses on the general problem of how to automatically obtain accurate building inner and/or outer building contours from ALS point clouds. In order to deal with this problem in an effective way, has been found that the created contours should accurately approximate the real building footprint so that accuracy of the geometric shapes can be maintained. In particular, the created contours should be organized into closed shapes according to a specific order without intersections (including self-intersections) to maintain the correctness of contour topology. At the same time, it is preferred that the created contours be light-weight and regular, thereby producing compact as well as visually appealing shapes.

Unlike the three categories of methods noted above, the present invention provides a building contouring framework for processing large-scale residential scenes by simultaneously considering geometry, topology, compactness and regularity. In particular, the framework of the present invention uses five steps: 1) Building identification, 2) Contour determination, 3) Contour decomposition, 4) Contour regularization, and 5) Contour generation. More specifically, the first step correctly identifies the instance-level building entities, thereby simplifying the complexity of processing geometry and topology for subsequent steps. In the second step, the present invention uses a topologically-aware propagation algorithm to elegantly trace initial building contours. These are consecutively decomposed into multiple linear primitives by an energy formulation by way of the third step. The topologically-aware propagation algorithm guarantees topological correctness. The decomposition formulation decomposes the contours in a manner that is as detailed as possible and thus guarantees the accuracy of geometric shapes. In the fourth step, the strengths of the hierarchical strategy are leveraged to make the linear primitives more regular at the global level. In the final step, compact contours are generated by only connecting anchor points in a nice way. In addition to the above methodology, the present invention introduces the following:
A novel topologically-aware propagation algorithm to elegantly trace the initial building contours from corresponding undirected graphs. More details will be presented in Section 2.2 below.
A novel global optimization algorithm for decomposing building contours into multiple linear primitives via solving a multi-label energy minimization formulation. This formulation simultaneously takes the point cloud consistency, piecewise continuity and label compactness into account [see Section 2.3].
A global level regularizer, from which regular building contour shapes are hierarchically learned and enforced via imposing the global priors, namely parallelism, homogeneity, orthogonality, and collinearity [see Section 2.4].

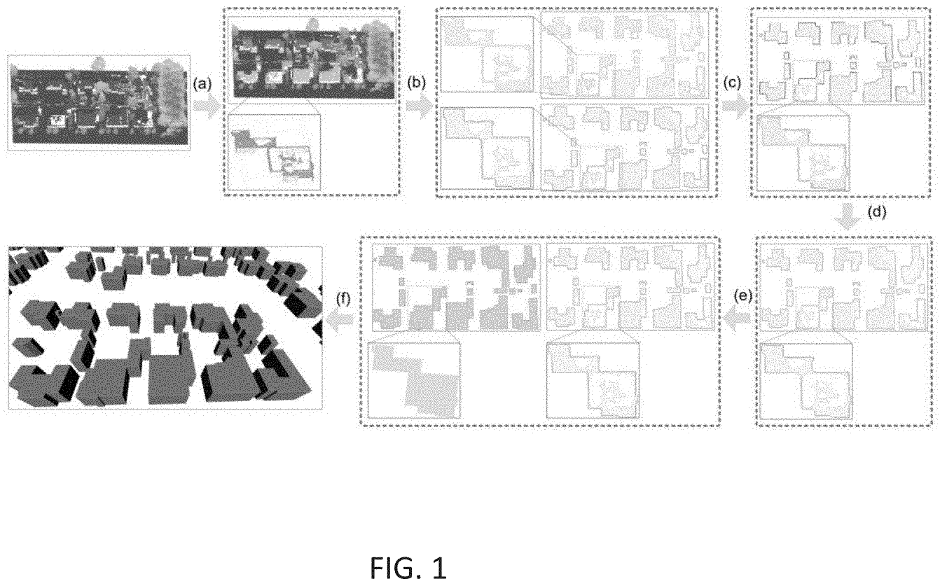

To generate the rectilinear building outer and inner contours of holes inside object (if, of course, such holes exist), the present invention uses methodology that consists of the following five steps that are outlined in FIG. 1. The individual buildings are first identified. This is followed by the extraction of the initial outer and/or inner contour points using a novel topologically-aware propagation algorithm. The initial building contours are then decomposed into multiple linear primitives through a fast energy minimization process. After this, the generated linear primitives and their associated parameter representation are provided as inputs to the regularizer. The regularizer progressively refines the shapes at a global level. In the last step, these regularized linear primitives are assembled to form watertight and manifold contours. The entire contouring framework takes as input a large-scale ALS point cloud of a residential scene and generates a set of polygons representing the contours of buildings. The building contours are further visualized as LoD1 building models.

### 2.1 Building Identification

Since the present invention uses individual building as inputs, these buildings should be correctly separated for subsequent processing. For this, the multiscale and hierarchical feature extraction method [39] to finalize the semantic labeling of 3D point clouds can be used. This method assigns a semantic label to each 3D point. Afterwards, 3D point clouds whose semantic properties are labeled with “building” are clustered into individual building entities.

In residential scenes, buildings are more densely distributed as compared to buildings contained in urban scenes. In fact, in several cases, it is difficult to individually separate adjacent buildings in residential areas. If these buildings cannot be correctly separated in advance, the contour generation algorithm will be affected, thereby leading to incorrect results. Multiple classic methods which have been used in the past to separate buildings and these are detailed below. A method is then selected that is capable of processing a selected scenario (large-scale residential scenes).

To achieve error-free individual building separation, the traditional component connection algorithm is embedded in the open source software package CloudCompare. This package uses a 3D grid deduced from the octree structure to organize the 3D point clouds. Selecting the different levels of octree determines the minimum gap between components. In particular, the higher the level, the smaller the gap it produces and more components might be generated and vice versa. Another open source software package, Computational Geometry Algorithms Library (CGAL), the corresponding module has been developed for processing the developable and non-developable shapes (surfaces). For processing developable shapes, this package can be used to perform a connected component search to identify the largest components by means of a regular grid generated by converting an unorganized point cloud into a 2D space. Conversely, for processing non-developable shapes, the connected components can be identified by computing a neighboring graph in 3D and walking on the graph. Other works, e.g., [5] and [6], search the connected components based on a Delaunay triangle data structure. More precisely, they use the predefined Euclidean distance and connectivity defined in a Delaunay triangle data structure as the principles for the propagation of components.

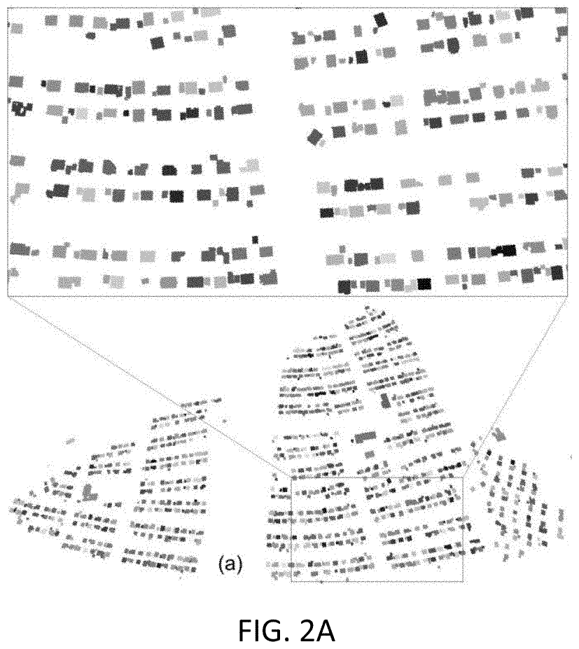

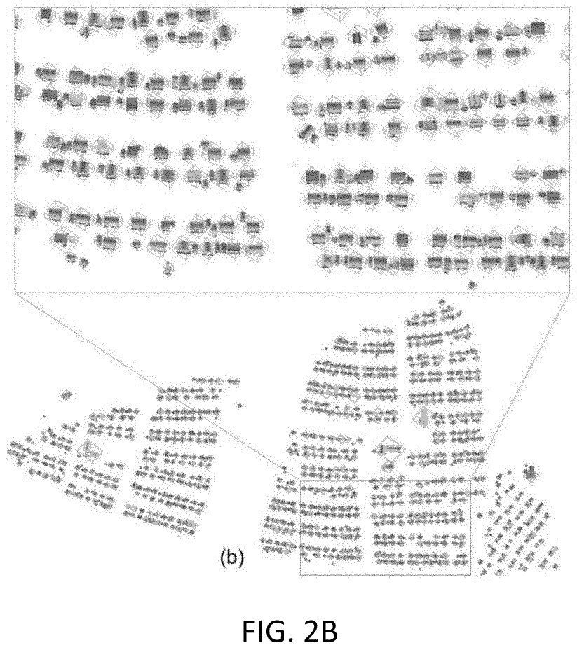

However, it must be noted that these algorithms only consider the simple Euclidean distance factor as a component clustering criterion. Setting approximate thresholds for urban scenes is relatively easy due to large gaps among buildings. In contrast, in residential areas, the selection of an appropriate threshold becomes more difficult. Partially because of this, the present invention may use density-based spatial clustering of applications with noise (DBSCAN) algorithm [12] to cluster individual buildings. This method takes into account a current point's density and numerous distance measures for component clustering. In addition, the method does not need to specify the component number and can simultaneously recognize the outliers. These advantages render the method capable of processing not only the urban scenes but also residential areas in cases where the point density does not vary significantly. If the point clouds have unevenly distributed densities, the ratio of point density (calculated by dividing the current point density to its neighborhood point density) may be used to redefine the current point's density. This improvement decreases the sensitivity of the predefined point density threshold and makes the point density threshold insensitive over a wide range of values. In addition, to better characterize the point clouds' geometric distributions/characteristics in 3D space, the Euclidean metric can be redefined and recalculated by considering the point's principal curvatures in a local coordinate system rather than in a global coordinate system adopted in the classic DBSCAN algorithm. Meanwhile, while the large-scale residential building contours are processed via DBSCAN, the neighboring point queries are accelerated by employing the kd-tree indexing technique. Using the above enhancements, more reasonable and meaningful instance-level segmentation results are achieved (see FIGS. 2A and 2B).

### 2.2 Initial Contour Determination

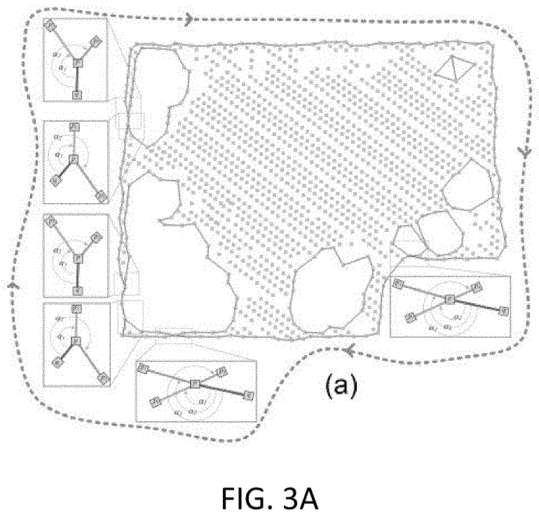

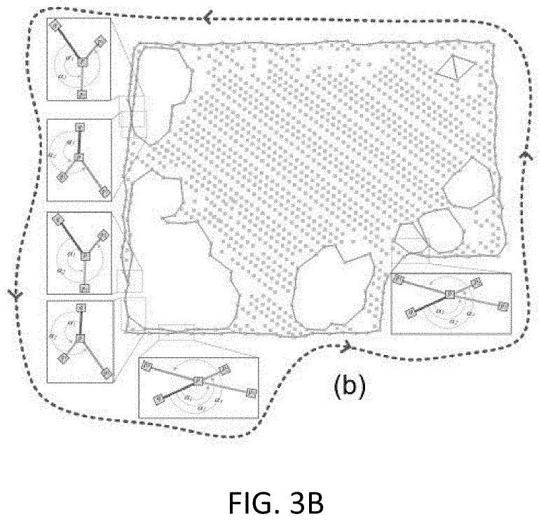

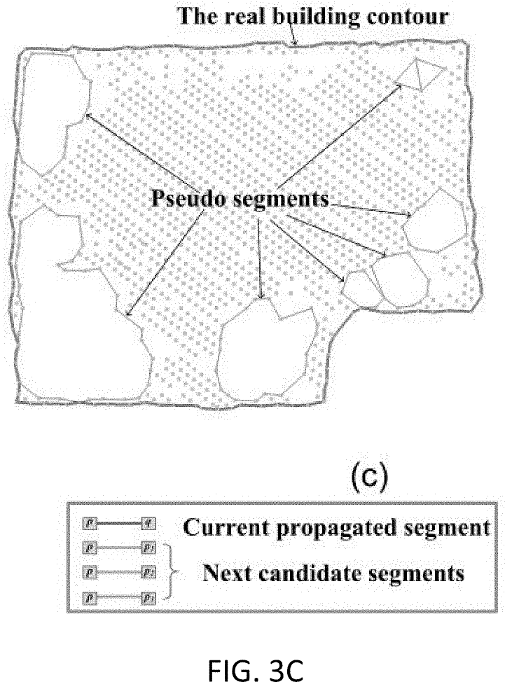

Once individual buildings have been successfully separated, the alpha-shape algorithm [11] can be used to trace outer and/or inner building contour segments from the projected 2D point sets. As the raw building point clouds are often contaminated by noise, outliers, and the different degree of missing data, the initial contour results from alpha shapes are corrupted by the pseudo segments, as is evident in FIG. 3C. Next, a novel topologically-aware propagation algorithm can be used to obtain the exact building inner and/or outer contours from the alpha-shape segments. Such a method can be implemented in 6 steps as follows:
Step 1: The alpha-shape segments are first organized into the undirected graph (UG).
Step 2: The arbitrary vertex with degree greater than 1 from the UG is chosen as the beginning propagation point.
Step 3: If the current point has degree 2, one of its connected and unvisited points is selected as the next point. If the current point has degree greater than 2, there are only two conditions for determining the next point from its adjacent candidate point set. As shown in FIG. 3A, (with the propagation in clockwise sequence in this case), the candidate point corresponding to the least azimuth angle α₁ is chosen as the next point. In contrast, as shown in FIG. 3B (where the propagation is in counter clockwise sequence), the least azimuth angle α₁ is determined according to counter clockwise sequence. In either case, the rotation order for determining the least azimuth angle and the sequence of the propagated segments (indicated by red color in FIG. 3C) should be kept identical. This step is performed recursively until the auto-propagated segments form a closed ring.
Step 4: A brute-force searching algorithm is applied to recursively execute steps 2 and 3 until a closed ring covering the maximum area is obtained—this is regarded as the exact outer building contour.
Step 5: Based on the remaining unvisited vertices, steps 2 through 4 are repeated until all of the inner closed rings have been extracted.
Step 6: The shape index [23] is adopted to distinguish whether or not the inner rings are the exact building inner contours.

It should be noted that, through this topologically-aware propagation algorithm, the problem of determining exact initial contours is transformed into a problem of searching for the largest area of closed ring based on UG. Although the brute-force strategy was adopted, the method is still efficient as it is applied on the reduced point clouds/segments generated from the alpha-shape method. Note that, for each individual building, only one outer building contour and possibly one or more inner contours commonly compose a complete building. Given the difficulty in working with point clouds, because of their noise, outliers, occlusions, and irregularities, the initial contour may contain many redundant points, noise, outliers, thereby forming irregular shapes. Sections 2.3 and 2.4 below will describe the method to generate the regular, watertight and manifold contours which approximate the building outlines.

### 2.3 Contour Decomposition

The goal of this step is to divide each rooftop contour into multiple linear primitives, where each primitive is consistent with respect to the actual building outline expression. In addition, the points from the same linear primitive must keep an identical label. More precisely, the problem under investigation can be explicitly stated as follows: Given an arbitrary contour, the optimal linear primitives are anticipated to be obtained by the optimal labeling process. Clearly, this problem is a multi-labeling problem, which can be solved through convex optimization. Therefore, one must first define an energy function which is constituted by multiple sub-energy terms. Below is a detailed explanation of how to solve the energy function through optimization.

### 2.3.1 Energy Terms

For this issue, the selected energy function consists of three sub-energy terms: alignment term, smoothness term, and fidelity term as follows:

E_{L}=E_{alignment}+η₁Eₛₘₒₒₜₕ+η₂E_{fidelity}, (1)

where E_{alignment} denotes the segmented linear primitives approximating their exact outlines as much as possible; Eₛₘₒₒₜₕ denotes the homogeneity of each of the linear primitives; and E_{fidelity} term is used to suppress the generation of too many trivial linear primitives. Parameters η₁ and η₂ are used to balance energy forces among these three terms and the choices for the values are discussed in Section 3.1 below.

For the E_{alignment} term, two factors including Euclidean distance and directional consistency are considered, i.e., the term E_{alignment} is composed of the following two sub-energy terms:

E_{alignment}=E_{distance}×E_{direction}, (2)

In the above equation, E_{distance} penalizes inconsistencies in the distance between a point and its associated linear primitive, and is given by

$${E}_{distance} = {\sum }_{i = 1}^{m} {\sum }_{j = 1}^{n} P - ln ( {P}_{r} ( {p}_{j} ∈ {L}_{i} ) ) {P}^{2} , \qquad ( 3 )$$

where

$${P}_{r} ( {p}_{j} ∈ {L}_{i} ) ∝ \frac{1}{\sqrt{2 π} {σ}_{j}} exp \{ - \frac{{dist ( {p}_{j} , {L}_{i} )}^{2}}{2 {( {σ}_{j} )}^{2}} \}$$

with dist(pⱼ,Lᵢ) being the Euclidean distance from the point to the linear segments. The point pⱼ with high probability density Pᵣ (pⱼϵLᵢ) is encouraged to be represented by the linear primitive Lᵢ.

As well, E_{direction} penalizes the inconsistency between the current contour point's local tangent and the directional vector of linear primitive and is given by

$${E}_{direction} = 1 - {\sum }_{i = 1}^{m} {\sum }_{j = 1}^{n} {PN}_{{P}_{j}} \cdot {N}_{{L}_{i}} {P}^{2} , \qquad ( 4 )$$

where N_{P}_{ⱼ} represents the local tangent at point pⱼ, N_{L}_{ⱼ} represents the directional vector of linear primitive Lᵢ and symbol • is the dot product of two directional vectors. If these two vectors have large deviations, the heavy penalties will be imposed.

As the points from each contour C explicitly store the clockwise or counterclockwise topology, only two points (which are directly connected with the current processing point as neighborhood system) are used to design the following smoothness term:

$${E}_{smooth} = {\sum }_{i = 1}^{m} {\sum }_{j = 1 \\ k ∈ ( j \pm 1 + \vert {L}_{i} \vert ) \% \vert {L}_{i} \vert}^{n} P exp \{ - {τ}_{j , k} \} {P}^{2} , \\ {τ}_{j , k} = dist ( {p}_{j} , {p}_{k} ) \times δ ( F ( {p}_{j} ) \neq F ( {p}_{k} ) ) , \qquad ( 5 )$$

where F(pⱼ) represents the labeling optimization process for point pⱼ and symbol % denotes modulo operator. Intuitively, this term is inversely proportional to the Euclidean distance between the neighboring points. To minimize Eq. 5, neighboring points tend to have similar labels. If only the two above-mentioned terms for optimization are considered, the linear primitives tend to be over-segmented. To prevent this from happening, i.e., producing the trivial linear primitives and maintain the linear primitive consistency with respect to the primitive's actual contours, the following fidelity term (Eq. 6) is employed:

$${E}_{fidelity} = {\sum }_{{L}_{i} ∈ L} P exp \{ - \frac{\vert {L}_{i} \vert}{{{max}_{i ∈ ( 1 , … , m )} ( \vert {L}_{i} \vert )}_{ }} \} {P}^{2} \times δ ( F ) , \\ δ ( F ) {=}^{def} \{ \begin{matrix}1 , & ∃ {p}_{j}^{c} \text{:} F ( {p}_{j}^{c} ) = {L}_{i} \\ 0 , & otherwise\end{matrix} , \qquad ( 6 )$$

where, |Lᵢ| represents the point number in Lᵢ and pⱼ^{c} denotes an arbitrary point pⱼ from contour C. The term

$${max}_{i ∈ ( 1 , … , m )} ( \vert {L}_{i} \vert )$$

represents the linear primitive with the maximum length in set L. E_{fidelity} penalizes the linear primitives with relatively smaller sizes, which tend to be merged with relatively large linear primitives, thereby eliminating the redundant labels, i.e., over-segmentation.

### 2.3.2 Optimization

Finding the label configuration that minimizes Eq. 1 is a non-convex optimization problem. Dynamic programming via the Gurobi solver, simulated annealing [19], belief propagation [40] and graph cuts [2] can provide a good approximation to the solution. For simplicity, the graph cuts are used to solve Eq. 1 when the initial label set L is provided. More specifically, the alpha-expansion algorithm is used to solve the Eq. 1, which transforms the optimization into a max-flow/min-cut problem based on graph data structure.

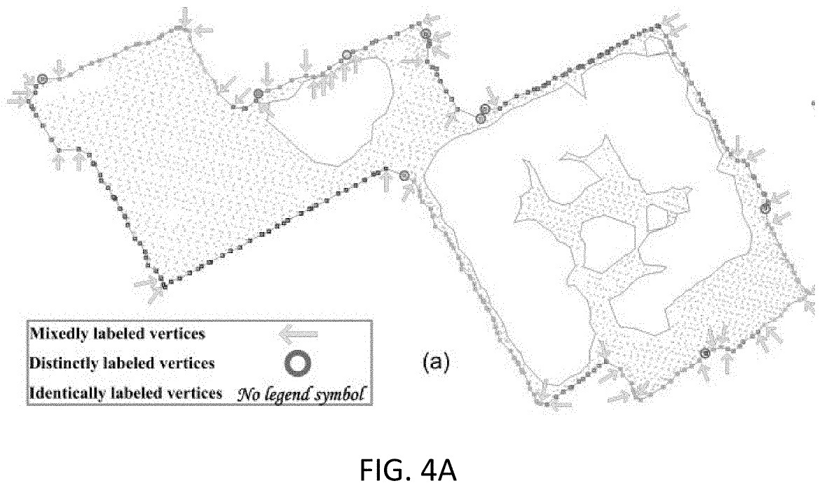

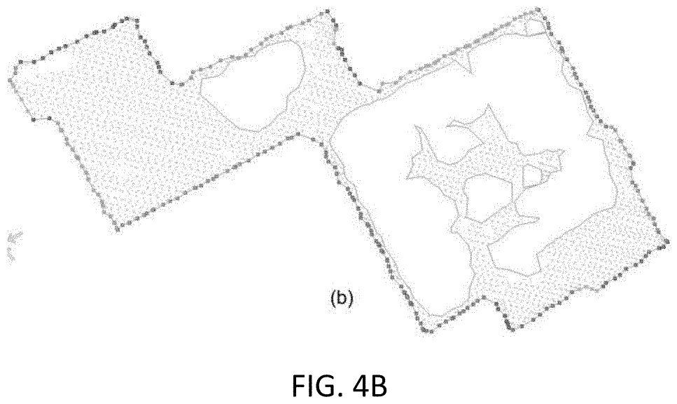

The most direct way to extract the potential linear primitives as the initial label set L is by using random sample consensus (RANSAC) algorithm [14]. However, the RANSAC method can produce numerous spurious linear primitives that seriously deviate from the actual building outlines. In this case, the small-sized linear primitives will be missed because their points are mistakenly assigned to spurious linear primitives, thus leading the reduced labels in set L as input. The corresponding primitives cannot be recovered after optimization because the new label can never be spontaneously generated during optimization. To solve this problem, the initial labels derived from RANSAC are reorganized by an undirected graph (UG). The contour points are classified into three categories according to their directly connected neighboring labels as follows:
1. Identically labeled vertex: The vertex and its two directly connected vertices have identical labels implying that the current vertex is from the interior of the linear primitive [see FIG. 4A].
2. Mixedly labeled vertex: The vertex only has the same label with one of the directly connected vertices implying that the current vertex is from two terminal points of the linear primitive [see FIG. 4A].
3. Distinctly labeled vertex: The vertex with distinctly connected labeled vertices, implies that the current vertex comes from the spurious linear primitives [see FIG. 4A].

From the UG, it can be observed that the linear primitive whose affiliated point number greater than or equal to 2 can be represented by type 1 and type 2 vertices. That is, any linear primitives with at least two consecutive identical label can be found by traversing type 1 and type 2 vertices from the UG. These linear primitives are regarded as one part of input labels. To better maintain the contour details during optimization, the segments that directly connect type 3 vertices are also added into the label set L as another part of input labels. These two parts of labels compose the whole inputs which will be optimized.

Note that during optimization, although the number of linear primitives is significantly reduced by introducing a fidelity term, several disconnected linear primitives (which are mathematically collinear but separated from each other) may be merged together. Ideally, only the contiguously connected vertices are capable of having an identical label, which meets the physical building contour reality. To resolve this issue, the contour points by UG are relabeled based on the principle that any contiguously connected vertices with the same label are identified as an individual linear primitive. The final linear primitives after optimization are shown in FIG. 4B.

### 2.4 Contour Regularization

Unfortunately, the decomposed linear primitives cannot be directly used due to irregular shapes and possible artifacts caused by noise and missing data. A regularization refinement step is needed before putting the results into the geospatial database. Motivated by the works in [29, 34, 22] for hierarchical decomposition of global regularity of planar proxies, a hierarchical strategy has been adopted because it can avoid the conflicts among different types of regularized operations and costly pairwise comparisons of different relationships of linear primitives. More specifically, the parallel linear primitives must first be found and then separate into multiple groups. Obviously, the linear primitives from each group are nearly parallel. After this, each group is evaluated to determine whether or not the group is consistent with respect to the building's dominant directions, followed by operations based on the orthogonal criterion among groups. Finally, it is determined whether or not the linear primitives within each group are collinear according to a proximity based criterion.

More precisely, given a set of linear primitives L detected in Section 2.3, this section aims to regularize L using four different performance criteria, namely parallelism, homogeneity, orthogonality and collinearity. In the present invention, given orientation and Euclidean distance tolerances ε and d, the entire regularization process is performed hierarchically based on the methods 1-4 given below.

1. Parallelism: If two linear primitives Lᵢ and Lⱼ are nearly parallel, i.e., |Lᵢ·Lⱼ|>1−ε, they are temporarily made exactly parallel. To avoid exhaustive linear primitive propagation, initial parallel groups are extracted via simple pairwise comparisons. Then, parallel propagation over these groups is performed. This process can improve the efficiency as well as eliminate the conflict relationships that exist in simple pairwise comparisons. In other words, the simple pairwise relationships can be further altered during the propagation. A linear primitive from a pairwise group can be merged into another group and also possibly separated into a new group. The detailed pseudocode is presented in Algorithm 1.

2. Homogeneity: If a linear primitive group gᵢ is nearly consistent with respect to the building dominant orientations, i.e., |gᵢ·B_{domi}|>1−ε, they are made exactly parallel to the dominant orientation. Note that when dominant building orientations are determined, another two orientations (45° and 135°) are added to form complete reference orientations, i.e., 0° (dominant orientation), 45°, 135° and 180° (orthogonal dominant orientation).

To obtain the building dominant directions B_{domi}, two different methods are followed. These methods will be chosen according to the considered scenarios, i.e., urban and residential scenarios. These two methods are as follows:
Data-driven Method: A histogram is built by analyzing the tangent directions of the building contour points, the directions of intersection edges between the facade and the terrain, and the directions of dominant ridge edges among rooftop planar primitives. In this histogram, each local maximum value represents one dominant direction, and all potential dominant directions are iteratively found. The data-driven method is suitable for processing urban scene of relatively large sizes with multiple dominant directions.
Hybrid-driven Method: In this method, it is assumed that the buildings have only two dominant directions which are orthogonal to each other. Based on this hypothesis, these two dominant directions are obtained through solving a unified energy function, i.e., Eq. 7. In fact, it is observed that the buildings from residential scenes have the following characteristics:
   i) Contour shape is relatively simple, and hence most of the buildings from these residential scenes have only two orthogonal dominants.
   ii) Each building has relatively small areas and sometimes suffers from severe occlusions by nearby trees—this implies that the extraction of dominant directions is not reliable by using the data-driven method. In contrast, the hybrid-driven method can well adapt to large-scale residential scenes and is more accurate in calculating the dominant directions in this scenario.

To design the hybrid-driven energy function, it is observed that initial building contour C has the minimum projection in building dominant and its orthogonal dominant directions. Thus, the loop integral of C is performed by minimizing the equation which is given as follows:

$${θ}^{*} = arg {min}_{θ} {\sum }_{i = 1}^{\vert C \vert} {PS}_{i} \cdot cos θ + {S}_{i} \cdot sin θ {P}^{2} , . \qquad ( 7 )$$

In this equation, |C| represents the total number of contour segments, Sᵢ indicates the length of i th segment, and θ* is the expected variable of building dominant direction (B_{domi}=θ*). The Gauss-Newton algorithm can then be used to solve Eq. 7, which can reach an accuracy of π/360 after less than ten iterations. The detailed pseudocode is given in Algorithm 2.

3. Orthogonality: If two linear primitive groups gᵢ and gⱼ are nearly orthogonal, i.e., |gᵢ·gⱼ|<ε, they are made exactly orthogonal. Specifically, all pairwise orthogonal groups are found. For each group, the direction of dominant group is first adjusted, making the direction consistent with the building's dominant orientations when they meet the homogeneity criterion. Then, another group from pairwise is made orthogonal to the dominant group accordingly. The detailed pseudocode is shown in Algorithm 2.

4. Collinearity: If two linear primitives Lᵢ and Lⱼ are nearly collinear, i.e., dis(Lᵢ,Lⱼ)<d, they are made exactly collinear. More specifically, the collinear primitives are obtained by the propagation over linear primitives within each group. After that, each collinear group is further segmented into different subgroups according to a proximity based criterion. The detailed pseudocode is presented in Algorithm 3.

The above mentioned four procedures have the following procedural objectives:
Parallelism which guarantees the entire building regularity;
Homogeneity which makes building contours consistent with their dominant/orthogonal dominant directions as much as possible;
Orthogonality which maintains building contours' sharp features; and
Collinearity which controls the different degrees of abstraction of building contours.

Essentially, parallelism is used to obtain the initial linear primitives' orientations, which is further enhanced via homogeneity and orthogonality procedures. However, collinearity is used to acquire the final positions of linear primitives. The accurate orientation and position commonly determine the final parameters of the linear primitives. It is noted that all the propagation operations are weighted by the total number of points within each linear primitive. In addition, in the regularization, only the linear primitives' parameters are modified. The corresponding points as well as the relationships between the linear primitive points and the associated parameters are left unaltered.

### 2.5 Contour Generation

In Section 2.3, the strict correspondences between the linear primitives and their associated contour points via UG were constructed. This topological relationship is very useful to form the watertight contours after the regularization. As previously mentioned [see Section 2.4], only the parameters of linear primitives are enhanced, and the topology correspondences are left unaltered. In addition, it should be noted that only some part of linear primitives are enhanced, and the remaining linear primitives' parameters are intact. Hence, one can obtain anchor points by circulating around pairwise neighboring linear primitives in UG. More precisely, if a linear primitive Lᵢ is neighbor with a linear primitive Lⱼ, there is an anchor point whose position is exactly at the intersection of Lᵢ and Lⱼ. The watertight contour is formed by consecutively connecting these anchor points. If a building is composed by multiple contours (with one or multiple inner hole contours), these are processed one by one, and they are organize into an ESRI shapefile format based on their inclusiveness (for the ESRI format, see https://www.arcgis.com). The above process leads to a building contouring via hybrid representation by simultaneously connecting enhanced and unaltered linear primitives, thereby increasing contouring flexibility.

### 3 Performance Evaluation and Discussions

In this section, various performance results obtained through qualitative and quantitative performance evaluation procedures are presented, analyzed and discussed. Firstly, the technical characteristics of the airborne laser scanning data are reviewed. Then, a qualitative and quantitative evaluation of contouring performance in terms of accuracy, robustness, topology, LoDs, compactness and scalability is presented and analyzed in a systematic manner. This includes discussions on thresholds and selection of their most appropriate values, as well as a detailed presentation of the numerous experiments which have been carried out in order to assess the performance of the proposed method.

### 3.1 Dataset Specifications and Parameter Setting

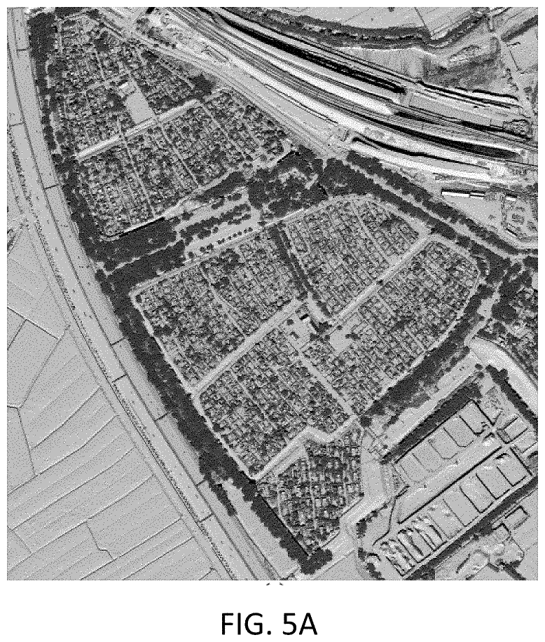

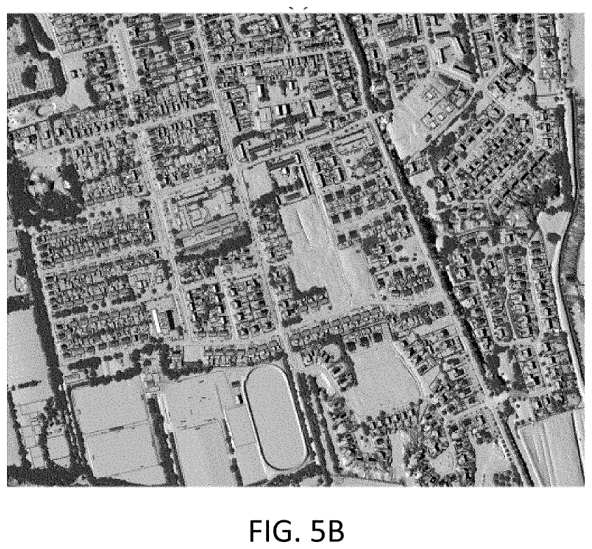

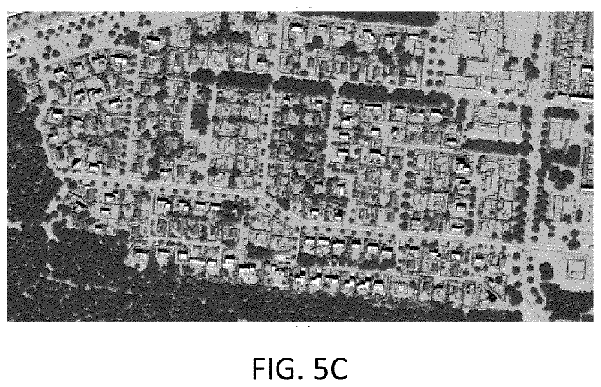

The dataset used is the Netherlands dataset AHN3 (Actueel Hoogtebestand Nederland). This is acquired by a third country-wide airborne laser scanning campaign. For the acquisition of the AHN3 dataset, various companies have used mostly the Riegl LMS-Q680i laser scanning sensor and sometimes the Riegl VQ-780i. The flight altitude depends on the internal procedures of the companies. In general, the flight altitude varies between 450 m and 500 m. An aircraft is always used for the data collection. The already obtained part of AHN3 dataset is freely available to the public via a central distribution platform PDOK¹ (Publieke Dienstverlening Op de Kaart). To facilitate the use of data, the whole of AHN3 dataset is divided into 1,100 small rectangular pieces, each of which covers an area of 6.25 km in north-south direction and 5.0 km in east-west direction. From the AHN3 dataset, three sites were selected. These will be denoted as Site 1, Site 2 and Site 3 for the evaluation of the method of the present invention. More specifically, Site 1 [see FIG. 5A] is dominated by the small-sized single-family houses, which poses a challenge for contouring algorithm because the many unstable small-sized linear primitives it contains. Site 2 [see FIG. 5B] contains the buildings with varied sizes and rooftop structures in different orientations. Point clouds from Site 3 [see FIG. 5C] are contaminated by a high degree of missing data. Thus, the selected scenes are appropriate for assessing the present invention. ¹ https://www.pdok.nl/nl/ahn3-downloads

Before analyzing the quality of reconstructed contours, all the relevant thresholds are analyzed and an explanation is given as to how to select their appropriate values. The parameter ρ of mean density is closely related to the raw dataset. For the AHN3 dataset used, the average density is 16 points/m², which means that the average point spacing is 0.25 m. In the enhanced DBSCAN algorithm, thanks to the Euclidean metric ψ redefined in a local coordinate system and improved point cloud density ϕ, they are more suitable to characterize point clouds' geometric relationship and spatial distribution. Furthermore, the enhancement makes instance-level segmentation parameters ψ and ϕ less sensitive to a wide range of values. Through experimentation, it was found that, by selecting ψ in the range [ρ,3ρ] and ϕ in the range [5,15] nearly identical results were obtained. For the coarse contour generation, the parameter α controls the delineation of building contours with various degrees of details. Generally, it is suggested to be set in the range [ρ,2ρ]. For this dataset, it is appropriate that α takes a relatively small value to maintain the details of building contours. However, selecting a very small value will produce pseudo contour points due to noise, outliers, missing data as well as uneven point density. Through trial and error experiments, it has been found that α≈1.5 ρ can achieve a balance between abstraction/representation of real building contours and suppression of pseudo contour points. For contour decomposition, considering the interaction and balancing mechanism involved in three types of energy forces, the same weight (η₁=η₂=1) is given to each energy term. During contour regularization, ε=10° and d=2ρ is set and this strikes a balance between abstraction and realism from aesthetic and accuracy perspectives. All the parameters, which have been used in the experiments, are listed in Table 1.

### 3.2 Accuracy and Time Efficiency

Overlapping Ratio (OR) and Root-Mean-Square-Error (RMSE) metrics were used for quantitative evaluation of the generated building contours. Given an initial building contour C derived from the topologically-aware propagation algorithm in Section 2.2 and the reconstructed building contour C′, the OR metric is defined as:

$$OR = \frac{{A}_{overlap} ( C , {C}^{′} )}{A ( C ) + A ( {C}^{′} ) - {A}_{overlap} ( C , {C}^{′} )} \times 100 \% , \qquad ( 8 )$$

where A(⋅) represents the corresponding polygon/contour's areas. Aₒᵥₑᵣₗₐₚ(C,C′) represents the intersection areas between contour C and C′. Clearly, OR evaluates the consistency of two geometric shapes, i.e., OR=1 indicates that two contour shapes are completely overlapped, whereas OR=0 indicates that there is no overlapping in contour reconstruction.

In addition to the above, the RMSE metric is used to measure the geometric accuracy of the reconstructed building contours with respect to the building contour points from C. More specifically, the Euclidean distance from each point p from C to their associated linear primitives Lᵢ is first calculated. Then, RMSE of each individual building is determined as follows:

$$RMSE = \sqrt{\frac{{\sum }_{i = 1}^{n} {\sum }_{∀ p ∈ {L}_{i}} Pp - {L}_{i} {P}^{2}}{{\sum }_{i = 1}^{n} \vert {L}_{i} \vert}} , \qquad ( 9 )$$

where Pp−LⱼP² represents the Euclidean distance from the point p to their associated linear primitives Lᵢ; |Lᵢ| denotes the number of points within Lᵢ.

According to the metrics OR and RMSE, the accuracy of three experimental results obtained from the AHN3 dataset is listed in Table 2. It can be seen that the average OR of three sites reaches up to 95%. Therefore, it can be concluded that the building contours created by the proposed method maintain a high consistency with respect to the real building geometry. In addition, the average RMSE value of three sites is from 0.067 m to 0.087 m, which implies that the accuracy of the reconstructed contours is consistent with a precision of 0.06 m of the AHN3 dataset. The maximum RMSE value from 0.192 m to 0.380 m further indicates that the maximum geometrical error is around the mean density of point clouds, i.e. 0.25 m. The quantitative performance evaluation results in Table 2 are obtained using a personal computer equipped with a 2.70 GHz Intel® Core™ i7-6820HQ CPU, 8 GB of main memory and an HD Graphics 530 GPU. The time requirement for the whole procedure, i.e., starting from the instance-level building segmentation to contour generation varies according to the size of the building. Having presented numerous small-sized buildings in Site 1, the average processing time for each building was only 0.18 s. In contrast, the average processing time of each building for Site 2 increases up to 1.04 s. However, this relatively high time requirement is understandable due to larger sized buildings. For the processing of 2,185 buildings from three sites, the time requirement for each building is an average of 0.51 s. This shows that the present invention has low-complexity processing requirements.

### 3.3 Robustness

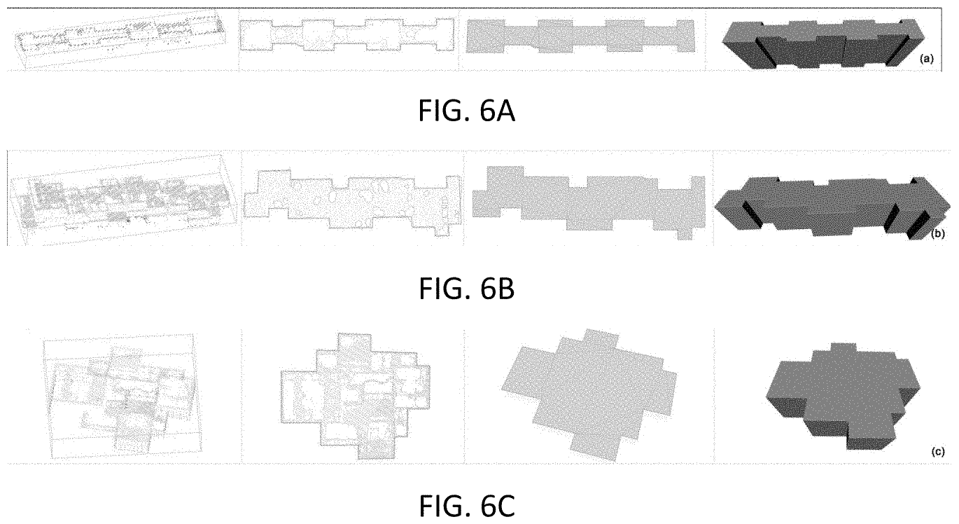

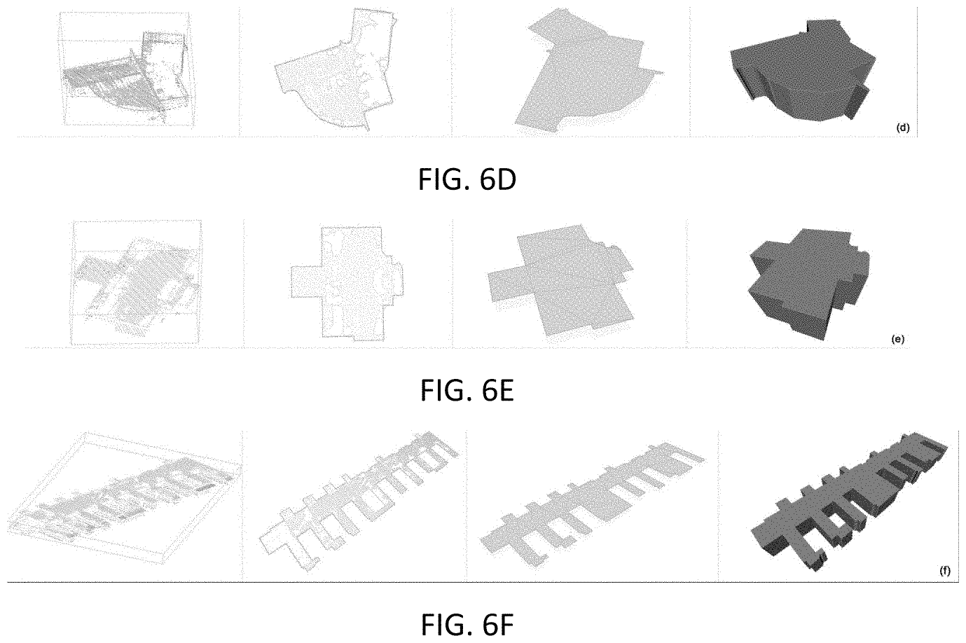

In the experiments, three types of buildings were used to evaluate the robustness of the present invention. These were: buildings with different levels of missing data, buildings having obvious global patterns embedded within contour geometries, and other buildings having complex geometric shapes. From FIGS. 6A-6F, six representative buildings with different levels of missing data were selected from the AHN3 dataset to test the robustness of the present invention when confronted with the missing data. The established UG from the coarse contour segments is very complicated due to the high level of missing data. However, even in this case, the topologically-aware propagation algorithm can still correctly trace the real boundaries from the UG by considering both the maximum value of OR and the closeness of contour candidates. On the basis of initial contours, the final building contours were generated (denoted by green lines in FIGS. 6A-6F) via the global decomposition and regularization procedures. To meet visually aesthetic requirements, these contours are triangulated and rendered by constructing their corresponding LoD1 models. Thanks to the topologically-aware tracing/propagation algorithm from UG, even though the buildings in FIGS. 6A-6F have large areas of point clouds missing, the exact or highly approximate geometric shapes are still obtained.

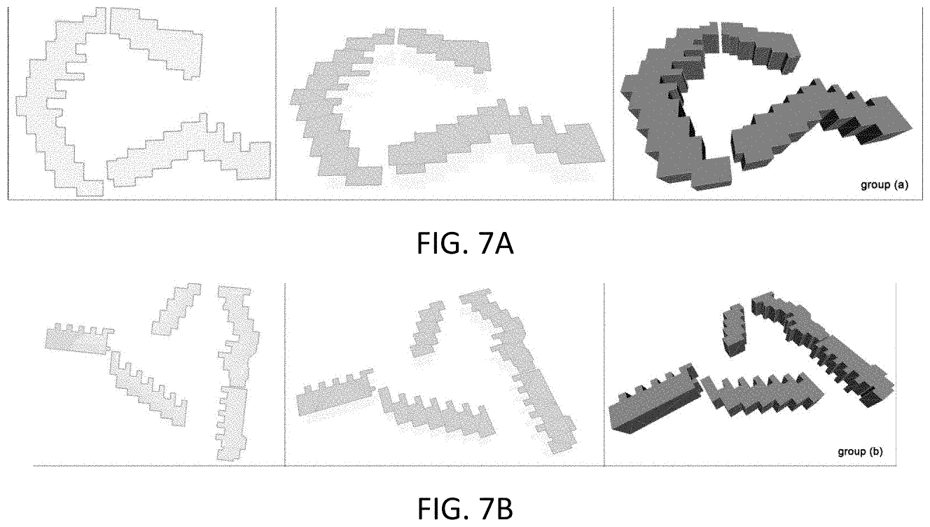

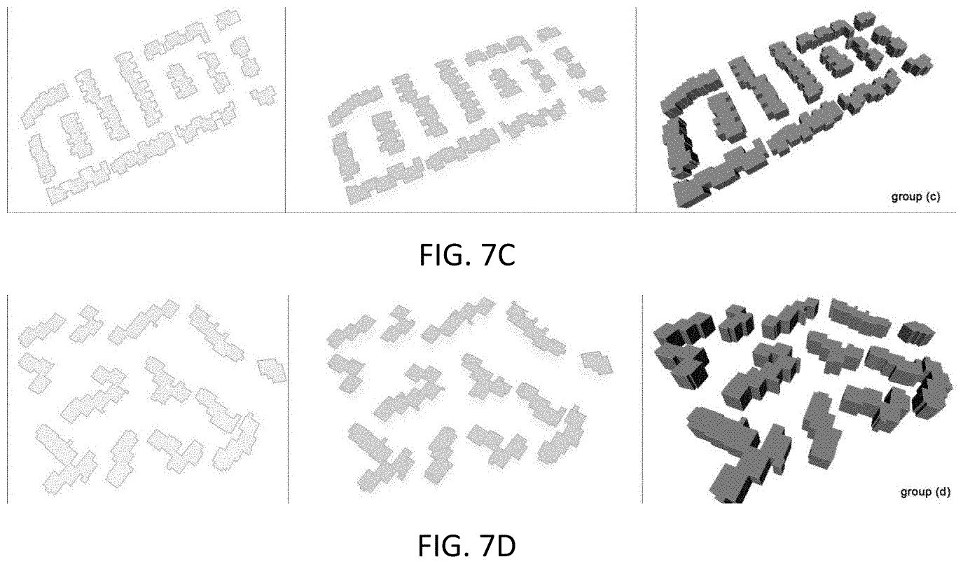

As mentioned before, the hierarchical regularization strategy is performed at a global level (within an individual building entity). In other words, the present invention can fully capture and recognize structural patterns of linear primitives and work pretty well, especially when contour shapes have obvious global patterns (e.g., symmetrical, orthogonal and repeatable geometries). This can be verified from the performance results presented in FIGS. 7A-7D, where, although geometric shapes of these four groups have too many details and point clouds have some degree of missing data, the present invention can completely recognize the potential patterns embedded within contour geometries and can integrate these global priors into the hierarchical regularization procedure.

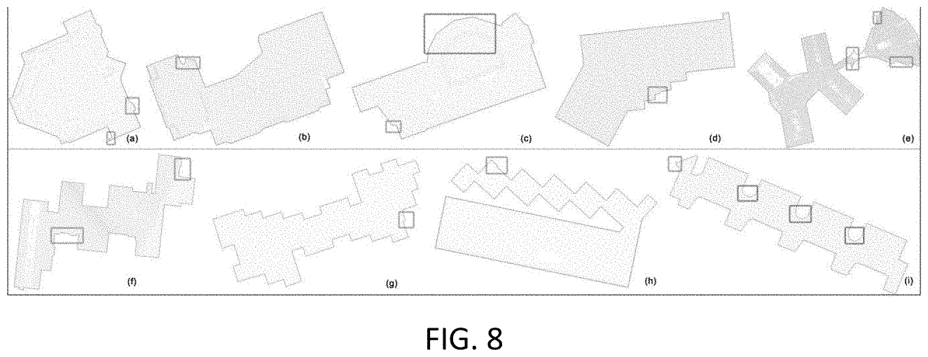

It should be noted that the present invention adopts a concept of hybrid representation. When buildings have the reliable characteristics of parallelism, homogeneity, orthogonality or collinearity, the linear primitives are made exactly regular to enhance the visual appearance. Otherwise, the corresponding linear primitives are preserved intact. This hybrid representation fully takes into account a trade off between accurate geometry and abstract representation, thereby imparting high flexibility to the present invention. Because of this loose-tight and flexible representation, the present invention can well capture the contours' details, which helps to allow the present invention to process very complex geometric shapes as is evident in FIG. 8. In FIG. 8, the red rectangles show that the details of building contours are well preserved, even though the global regularized procedures are employed. Meanwhile, the present invention has the capability to fit nonlinear geometric parts (indicated by blue rectangles) by linear approximations.

### 3.4 Topology

The topology of the created building contours was evaluated from the following four perspectives:
Closeness: The anchor points from each building contour should be organized by clockwise or counterclockwise sequences to form the closed rectilinear polygon. The closure of contour is the foundation for the generation of water-tight LoD1 building models.
Self-intersection: The segments that constitute the building contours are not allowed to self-intersect, except for consecutive segments in their common anchor vertex. Building contour topology without self-intersection is a prerequisite for the in-depth geometric analysis.
Intersection: The contours from different individual building entities are not allowed to intersect together, which guarantees the uniqueness of each entity.
Inclusion: If a building is composed of one or more inner contours, they should be jointly organized according to their inclusion relationships.

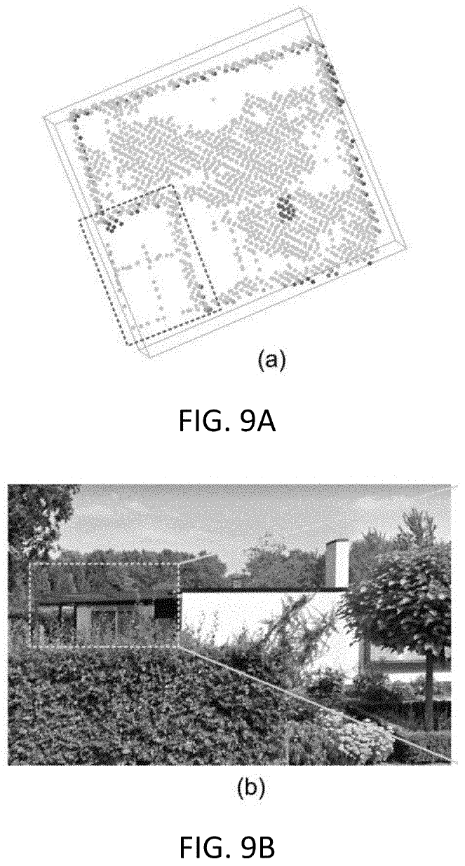

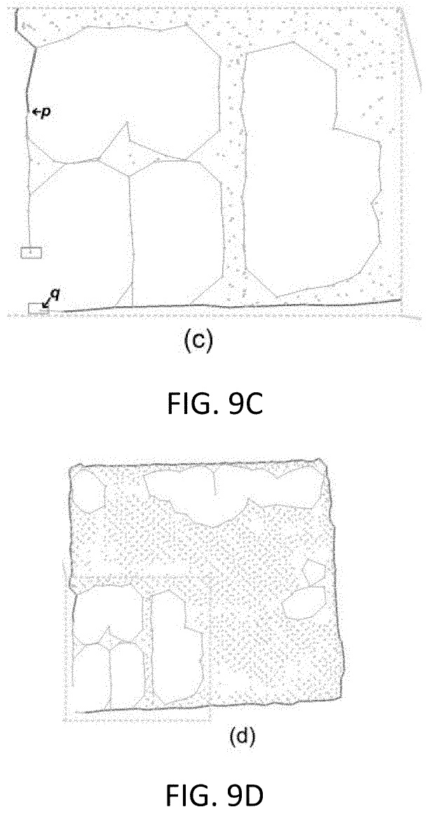

Following these principles, a constrained Delaunay triangulation algorithm [31] was used to triangulate each building entity to check whether or not there exist closeness, self-intersection, or intersection topological errors. If the triangulation performs successfully, the reconstructed building contours are topologically error-free. Otherwise, there exist topological errors because it is always true that at least one of the first three principles is not met. For example, as shown in FIG. 9A, the building with flat rooftop structure is chosen from the AHN3 dataset and suffers from missing data because part of rooftop is composed of some special materials (e.g., glasses or shiny piece of metal) as evident from the corresponding Google™ street view image in FIG. 9B. In this case, the laser beam can pass through the glass or produce specular reflection on shiny surface, thereby causing serious missing data. After the construction of the UG from these corrupted point clouds, there probably exist the vertices with degree of 1, indicated by red rectangles in FIG. 9C. In this case, the present invention, beginning from vertex p, is interrupted at the vertex q with degree of 1, thus leading to an unclosed contour, denoted by red contour segments shown in FIG. 9D. Fortunately, this situation rarely happens. As illustrated in FIGS. 6, 8-12, the light green triangles indicate that the present invention can guarantee that the generated building contours are closed, without intersection and self-intersection.

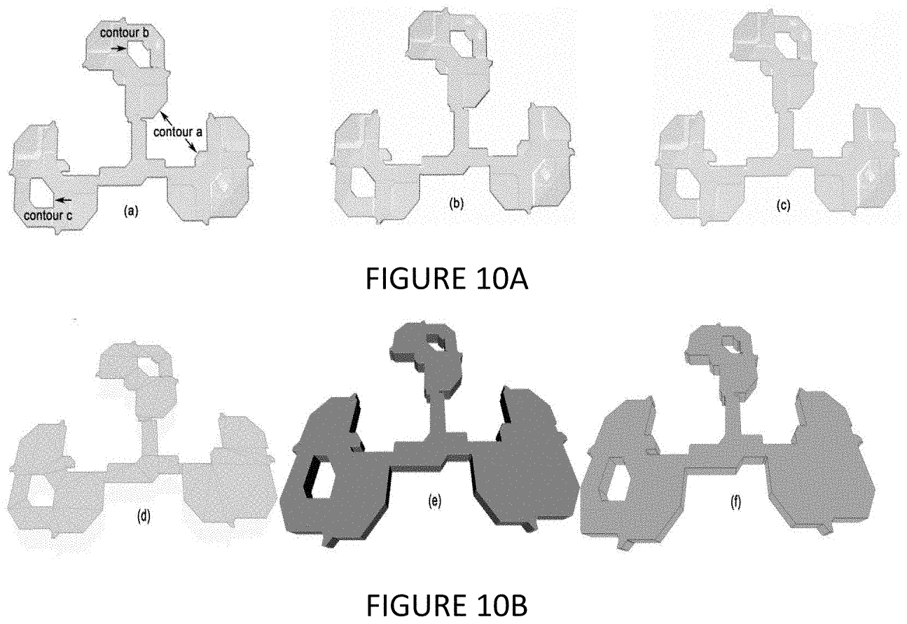

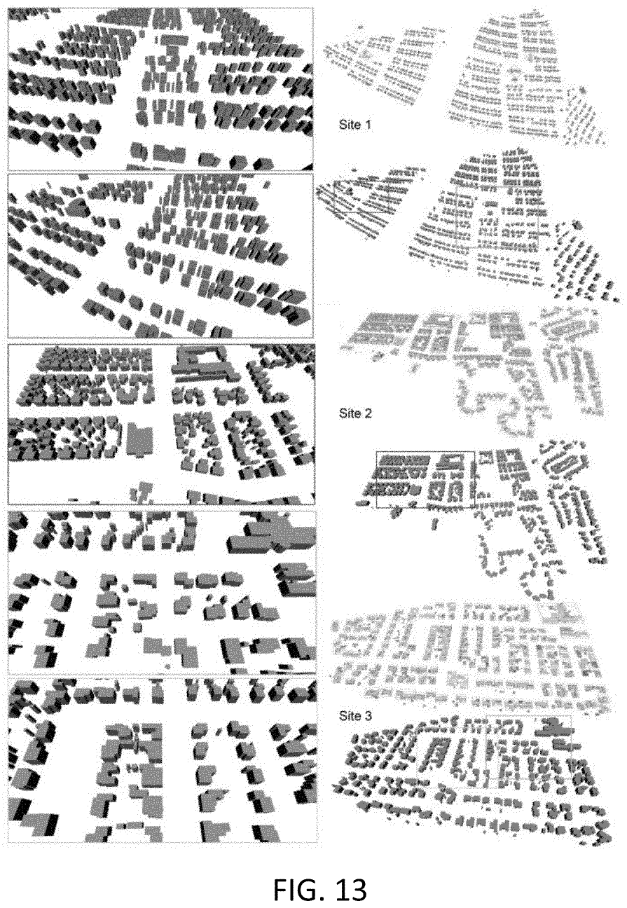

From FIGS. 10A-10B, the building complex includes only one outer contour a and two other inner hole contours b and c. The present invention can accurately extract these contours and regularize them in a uniform framework at a global level. The created contours are successfully organized according to their inclusion relationship, thereby highlighting two inner holes within the interior of building complex. The fact that the topology is accurate and correct, can be also proved by the large-scale LoD1 building models generated from the created contours as evident in FIG. 13.

### 3.5 LoDs

Different levels of details (LoDs) of building contours are extensively used in different practical applications. How to choose the most suitable LoDs contours is determined by different factors, including data acquisition cost, time and labor investment, target applications, and user needs. For example, if the building contours are mainly used in high-resolution mapping for autonomous and unmanned vehicles, the building contours are needed with a lot of detail. In urban planning or GIS-related (Geographic Information Systems) spatial analysis at micro-scale level, relatively simplified building contours without too many details can meet the requirements. In large-scale visualization and geometric rendering fields, they need building contours at different LoDs rather than a fixed LoD abstraction/representation. For such uses, a series of building contours with different LoDs should be created on the fly to enhance the geometric rendering efficiency and to improve user experiences. In general terms, the capability to automatically generate building contours with different LoDs is a critical criterion for evaluating the flexibility of the present invention.

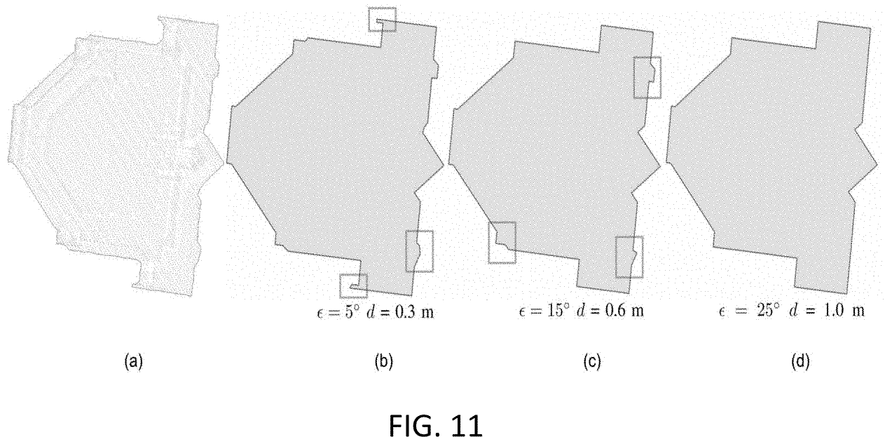

It has been found that the hierarchical regularization portion of the present invention, when carried out at a global level, has the ability to generate building contours with multiple LoDs by jointly tuning the parameters s and d. As shown in FIG. 11, by progressively increasing the values of the parameters s and d, the details denoted by red rectangles are disappearing and the contour shows more regular, compact, and higher levels of abstraction/granularity. As previously mentioned, during the contour abstraction, a trade off between geometric accuracy and outline abstraction/representation is made to commonly determine which particularly detailed LoDs are adopted for specific applications.

### 3.6 Compactness

The compactness of building contour is another important measure which directly determines whether or not the created building contours are lightweight. That is, the created contours with fewer vertices tend to be more compact and lightweight. Otherwise, building contours contain more redundant vertices on the premise of representing the same geometric accuracy. Clearly, the lightweight contours provide convenient ways for geospatial data storage, web transmission, and acceleration of rendering. To make a comprehensive assessment of contour's compactness, the Compactness Ratio (CR) is used. This is calculated by dividing the number of created contour C′ vertices to the number of vertices within initial contours C [see Section 2.2] to represent the degree of created contours' compactness. Table 3 reports statistical CR results for the considered three residential scenes. This table shows that the compactness ratio is around 10% for the three residential scenes, although the compactness ratio in Site 1 is slightly higher than the other two residential scenes due to the existence of many small-sized buildings. According to this reasoning, it can be inferred that more compact representations far below 10% can be expected when processing urban scenes with numerous large-size building complexes.

### 3.7 Scalability

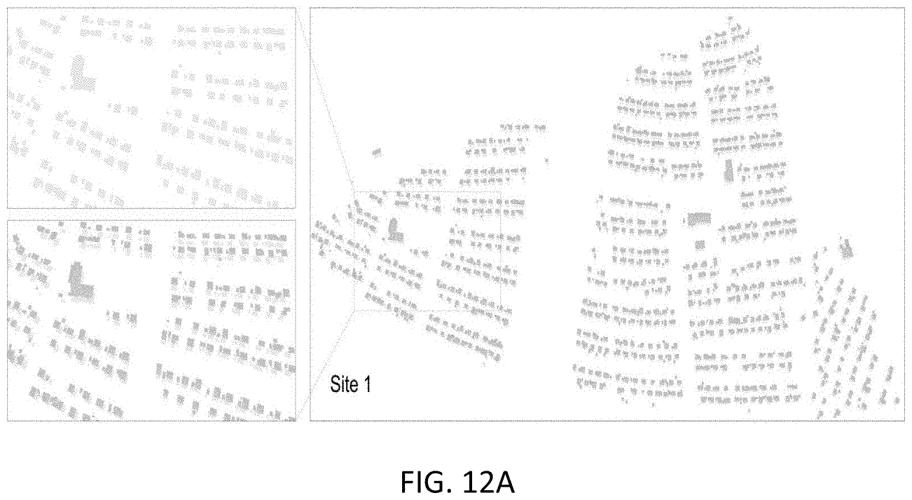

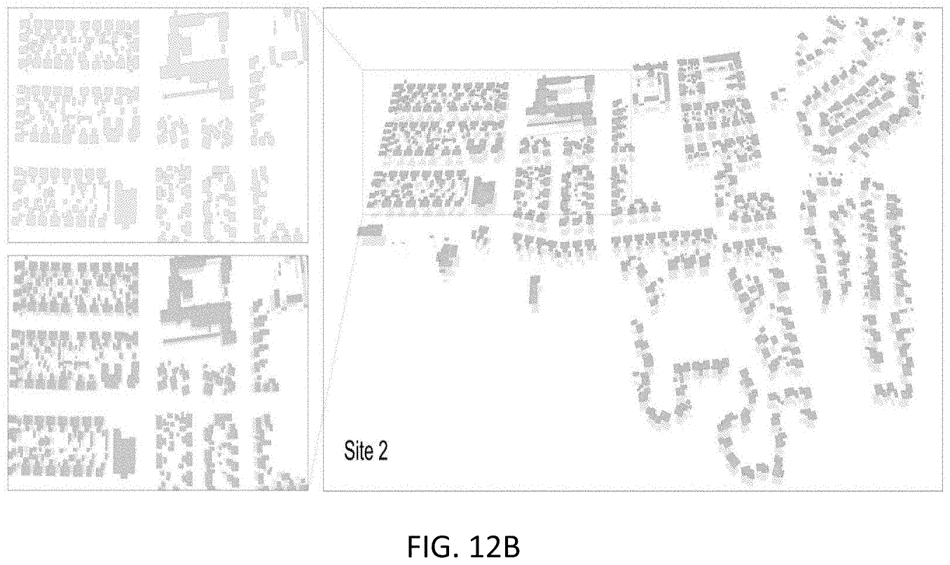

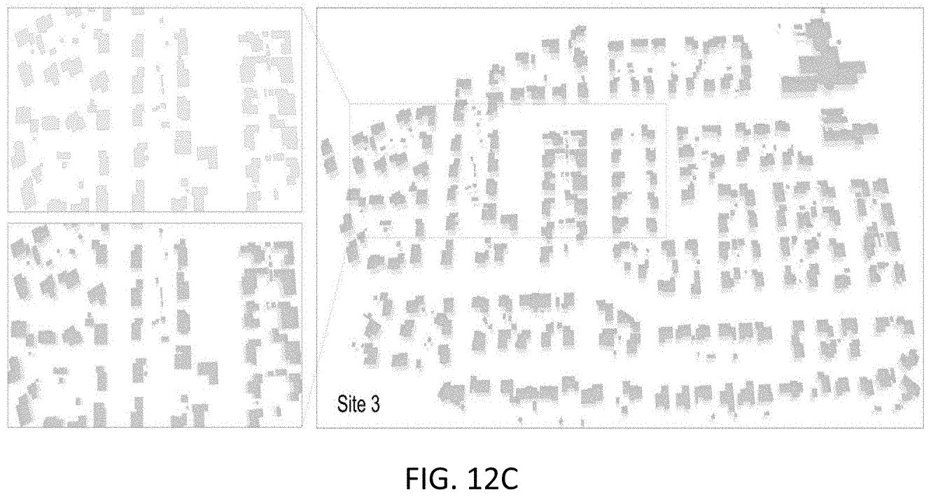

Scalability is a comprehensive measure representing the overall performance of the present invention. If the present invention is scalable, on the one hand, it should have the capability to deal with the imperfect point clouds, e.g., noise, outliers, missing data and irregularity. On the other hand, it should have the capability to process a wide variety of complex geometric shapes, e.g., nolinear shapes, shapes with inner holes, shapes embedded with some specific patterns, etc. To test the present invention, 2,186 buildings from the three residential scenes [see FIG. 5] were used to evaluate the scalability of the invention. The successful operation of the methodology of the invention can be seen from the performance results of FIGS. 12A-12C and FIG. 13. As can be seen, 2,185 building contours were successfully reconstructed with only one building [see FIG. 9] having topological errors due to severe missing data on the rooftop of the building. Because of the instance-level segmentation, the pipeline is provided with accurate individual entity as input, thereby decreasing the complexity of the initial contour extraction. In addition, the decomposition optimization can maintain the geometric details as much as possible (as demonstrated in FIG. 4B), thereby allowing the present invention to deal with more complex contours. Besides, the hybrid representation concept is deeply embedded in the regularization and contour generation procedures, thereby further increasing the flexibility of the present invention. The above advantages commonly guarantee the scalability of the present invention.

The present invention presents a novel building contouring algorithm from large-scale airborne laser scanning point clouds. In one implementation, starting from an enhanced DBSCAN algorithm, the individual building entities are obtained via an instance-level segmentation. Although the point clouds are corrupted by point irregularities and a high degree of missing data, the segmented individual entities tend to be more meaningful and reasonable [see FIG. 2]. Meanwhile, this step decreases the geometry complexity by providing accurate individual building entity as input for the subsequent topologically-aware propagation step. This propagation step progressively traces the exact outer and inner building contours. In addition to this, the present invention also provides a multi-label energy minimization formula coupled with a series of factors, including consistency, piecewise continuity and label compactness, to decompose building contours into multiple linear primitives. By tightly-coupled interactions among three energy forces in a fast energy minimization process, a global solution can be obtained via global optimization. The optimized linear primitives of each building have been further simultaneously regularized by hierarchically employing parallelism, homogeneity, orthogonality, and collinearity criteria. It is noted that decomposition optimization and regularization are both established at the global level, i.e., individual building entity. Because of this, the linear primitives and the regularized results are the globally optimal solution. The resulting method is robust enough to handle complex shapes, including shapes with holes, shapes embedded within the specific patterns, and shapes with some nonlinear parts. Moreover, the method of the invention is not sensitive to the quality of point clouds. Even if a point cloud density is uneven, the instance-level segmentation of the invention can still recognize each entity, as evident in FIG. 2. Even if the point clouds have severe missing data due to occlusions, self-occlusions, laser signal absorption, laser signal transmission, or laser signal specular reflection, the method of the invention can deal with these adverse situations, as shown in FIGS. 6A-6F. In particular, the present invention is anticipated to be used for contouring city-scale or even national-scale buildings. Tests using three sites from the AHN3 dataset show that the present invention only failed to process a single building, thereby implying the scalability of the invention.

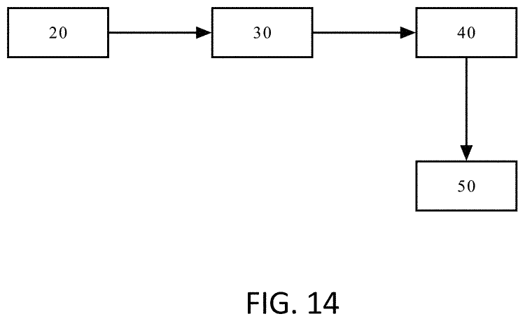

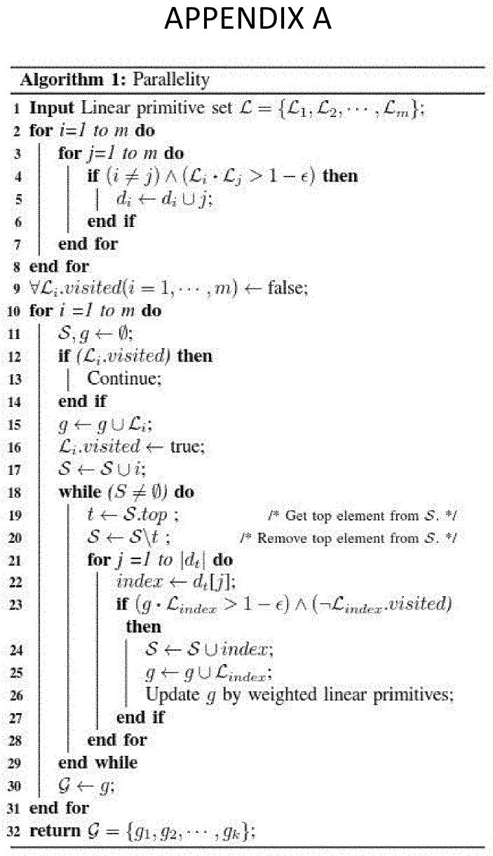

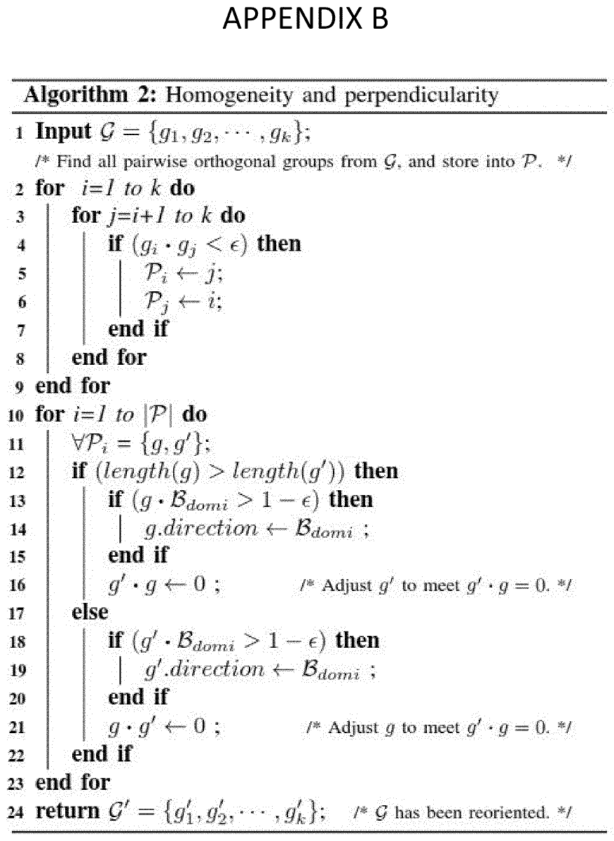

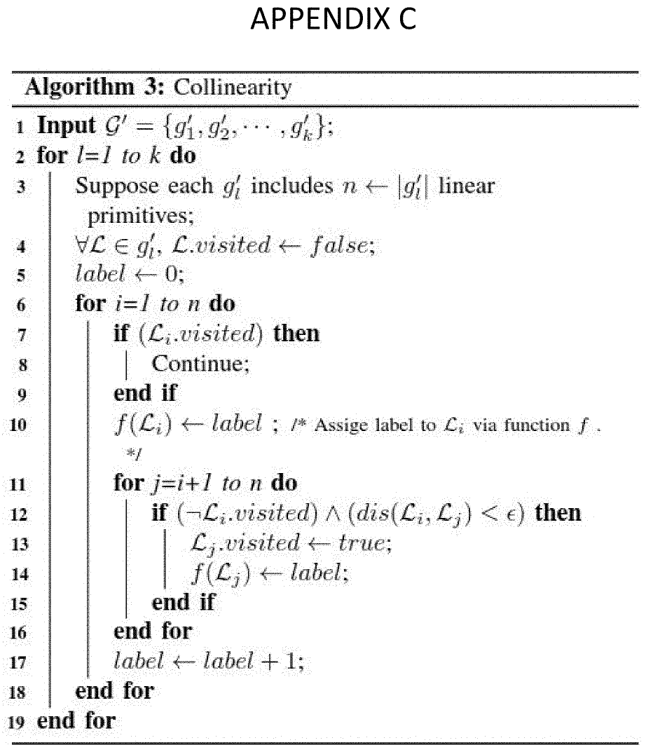

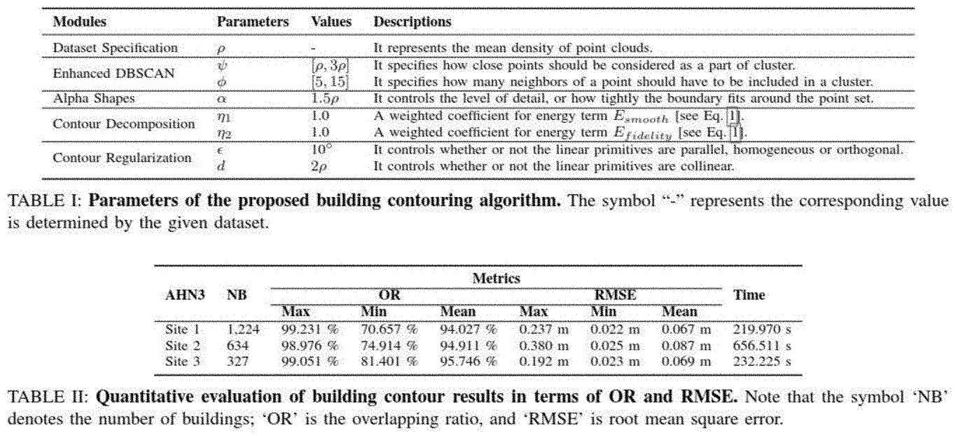

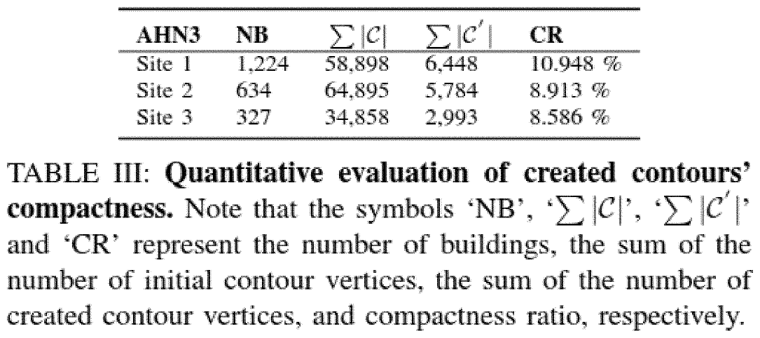

Referring to FIG. 14, a block diagram of a system according to one aspect of the invention is illustrated. As can be seen, the system 10 includes a building identification module 20, a contour determination module 30, a contour decomposition module 40, a contour regularization module 50, and a contour generation module 50. These modules sequentially operate on input data to produce building contours from point cloud data as input.

The first module, the building identification module 20, takes in point cloud data and identifies building entities. The identified building entities are then received by the contour determination module 30 and this module 30 produces initial building contour traces. The initial building contour traces are then consecutively decomposed by contour decomposition module 40 into linear primitives that are topologically correct. The contour regularization module 50 then regularizes the linear primitives and, finally, the final contours are generated by connecting the anchor points using the contour generation module 50.

It should be noted that other uses for the above invention are possible. As examples, the present invention may be used to generate building contours from multi-spectral satellite images. Segmenting individual buildings from these images may be accomplished with the help of artificial intelligence and/or deep learning methods and systems.

For ease of reference, the pseudo-code for Algorithms 1-3 are provided in the Appendices A-C attached hereto.

The references noted above are as follows:
[1] M Awrangjeb. Using point cloud data to identify, trace, and regularize the outlines of buildings. International Journal of Remote Sensing, 37 (3): 551-579, 2016.
[2] Yuri Boykov, Olga Veksler, and Ramin Zabih. Fast approximate energy minimization via graph cuts. IEEE Transactions on pattern analysis and machine intelligence, 23(11): 1222-1239,2001.
[3] John Canny. A computational approach to edge detection. In Readings in Computer Vision, pages 184-203. Elsevier, 1987.
[4] Liang Cheng, Jianya Gong, Xiaoling Chen, and Peng Han. Building boundary extraction from high resolution imagery and lidar data. International Archives of the Photogrammetry, Remote Sensing and Spatial Information Sciences, 37 (PART B3):693-698, 2008.
[5] Dong Chen, Ruisheng Wang, and Jiju Peethambaran. Topologically aware building rooftop reconstruction from airborne laser scanning point clouds. IEEE Transactions on Geoscience and Remote Sensing, 55(12):7032-7052, 2017.
[6] Dong Chen, Liqiang Zhang, P Takis Mathiopoulos, and Xianfeng Huang. A methodology for automated segmentation and reconstruction of urban 3-d buildings from as point clouds. IEEE Journal of Selected Topics in Applied Earth Observations and Remote Sensing, 7(10):4199-4217, 2014.
[7] Min Chen, Hui Lin, Deer Liu, Hongping Zhang, and Songshan Yue. An object-oriented data model built for blind navigation in outdoor space. Applied Geography, 60:84-94, 2015.
[8] Sophie Crommelinck, Rohan Bennett, Markus Gerke, Michael Ying Yang, and George Vosselman. Contour detection for uav-based cadastral mapping. Remote sensing, 9(2):171, 2017.
[9] Mark De Berg, Marc Van Kreveld, Mark Overmars, and Otfried Cheong Schwarzkopf. Computational geometry. Springer, 2000.
[10] David H Douglas and Thomas K Peucker. Algorithms for the reduction of the number of points required to represent a digitized line or its caricature. Cartographica: The International Journal for Geographic Information and Geovisualization, 10(2):112-122, 1973.
[11] Herbert Edelsbrunner and Ernst P Mücke. Three-dimensional alpha shapes. ACM Transactions on Graphics (TOG), 13(1):43-72, 1994.
[12] Martin Ester, Hans-Peter Kriegel, Jorg Sander, Xiaowei Xu, et al. A density-based algorithm for discovering clusters in large spatial databases with noise. In Kdd, volume 96, pages 226-231, 1996.
[13] Antonio Juliano Fazan and Aluir Porfrio Dal Poz. Rectilinear building roof contour extraction based on snakes and dynamic programming. International Journal of Applied Earth Observation and Geoinformation, 25:1-10, 2013.
[14] Martin A Fischler and Robert C Bolles. Random sample consensus: a paradigm for model fitting with applications to image analysis and automated cartography. Communications of the ACM, 24 (6):381-395, 1981.
[15] RA Jarvis. Computing the shape hull of points in the plane. In Proceedings of the IEEE Computing Society Conference on Pattern Recognition and Image Processing, pages 231-241. New York, 1977.
[16] Jaewook Jung, Yoonseok Jwa, and Gunho Sohn. Implicit regularization for reconstructing 3d building rooftop models using airborne lidar data. Sensors, 17(3):621, 2017.
[17] Florent Lafarge, Xavier Descombes, Josiane Zerubia, and Marc Pierrot-Deseilligny. An automatic building reconstruction method: a structural approach using high resolution satellite images. In Image Processing, 2006 IEEE International Conference on, pages 1205-1208. IEEE, 2006.
[18] Minglei Li, Liangliang Nan, Neil Smith, and Peter Wonka. Reconstructing building mass models from uav images. Computers & Graphics, 54:84-93, 2016.
[19] Stan Z Li. Markov random field modeling in image analysis. Springer Science & Business Media, 2009.
[20] Zhilin Li, Haowen Yan, Tinghua Ai, and Jun Chen. Automated building generalization based on urban morphology and gestalt theory. International Journal of Geographical Information Science, 18(5): 513-534, 2004.
[21] Bo Mao, Yifang Ban, and Lars Harrie. A multiple representation data structure for dynamic visualisation of generalised 3d city models. ISPRS Journal of Photogrammetry and Remote Sensing, 66(2):198-208, 2011.
[22] Sven Oesau, Florent Lafarge, and Pierre Alliez. Planar shape detection and regularization in tandem. In Computer Graphics Forum, volume 35, pages 203-215. Wiley Online Library, 2016.
[23] Theodosios Pavlidis. A review of algorithms for shape analysis. Computer graphics and image processing, 7(2):243-258, 1978.
[24] Jiju Peethambaran and Ramanathan Muthuganapathy. A non-parametric approach to shape reconstruction from planar point sets through delaunay filtering. Computer-Aided Design, 62:164-175, 2015.
[25] Charalambos Poullis. A framework for automatic modeling from point cloud data. IEEE transactions on pattern analysis and machine intelligence, 35(11):2563-2575, 2013.
[26] Judith M S Prewitt. Object enhancement and extraction. Picture processing and Psychopictorics, 10(1):15-19, 1970.
[27] Lawrence G Roberts. Machine perception of three-dimensional solids. in Optical and Electro-Optical Information Processing (J. T Tippett et al., Eds), MIT Press, Cambridge, Mass., pages 159-197, 1963.
[28] Duda Ro and Hart Pe. Pattern classification and scene analysis. 1973.
[29] Aparajithan Sampath and Jie Shan. Building boundary tracing and regularization from airborne lidar point clouds. Photogrammetric Engineering & Remote Sensing, 73(7):805-812, 2007.
[30] Jean Serra and Pierre Soille. Mathematical morphology and its applications to image processing, volume 2. Springer Science & Business Media, 2012.
[31] Jonathan Richard Shewchuk. Delaunay refinement algorithms for triangular mesh generation. Computational geometry, 22(1-3):21-74, 2002.
[32] Gunho Sohn, Yoonseok Jwa, Jaewook Jung, and H Kim. An implicit regularization for 3d building rooftop modeling using airborne lidar data. ISPRS Annals of the Photogrammetry, Remote Sensing and Spatial Information Sciences, 1(3):305-310, 2012.
[33] Satoshi Suzuki et al. Topological structural analysis of digitized binary images by border following. Computer vision, graphics, and image processing, 30(1):32-46, 1985.
[34] Yannick Verdie, Florent Lafarge, and Pierre Alliez. Lod generation for urban scenes. ACM Transactions on Graphics, 34(3):30:1-14, 2015.
[35] Vivek Verma, Rakesh Kumar, and Stephen Hsu. 3d building detection and modeling from aerial lidar data. In 2006 IEEE Computer Society Conference on Computer Vision and Pattern Recognition, volume 2, pages 2213-2220. IEEE, 2006.
[36] Jun Wang and Jie Shan. Segmentation of lidar point clouds for building extraction. In American Society for Photogramm. Remote Sens. Annual Conference, Baltimore, Md., pages 9-13, 2009.
[37] Ruisheng Wang, Jiju Peethambaran, and Dong Chen. Lidar point clouds to 3-d urban models: A review. IEEE Journal of Selected Topics in Applied Earth Observations and Remote Sensing, 11(2):606-627, 2018.
[38] Ruisheng Wang, Lei Xie, and Dong Chen. Modeling indoor spaces using decomposition and reconstruction of structural elements. Photogrammetric Engineering & Remote Sensing, 83(12):827-841, 2017.
[39] Zhen Wang, Liqiang Zhang, Tian Fang, P Takis Mathiopoulos, Xiaohua Tong, Huamin Qu, Zhiqiang Xiao, Fang Li, and Dong Chen. A multiscale and hierarchical feature extraction method for terrestrial laser scanning point cloud classification. IEEE Transactions on Geoscience and Remote Sensing, 53(5):2409-2425, 2015.
[40] Yair Weiss and William T Freeman. On the optimality of solutions of the max-product belief-propagation algorithm in arbitrary graphs. IEEE Transactions on Information Theory, 47(2): 736-744, 2001.
[41] Shaobo Xia and Ruisheng Wang. A fast edge extraction method for mobile lidar point clouds. IEEE Geoscience and Remote Sensing Letters, 14(8):1288-1292, 2017.
[42] Bisheng Yang, Zheng Wei, Qingquan Li, and Jonathan Li. Semiautomated building facade footprint extraction from mobile lidar point clouds. IEEE Geoscience and Remote Sensing Letters, 10(4):766-770, 2013.
[43] Jianhua Yan, Keqi Zhang, Chengcui Zhang, Shu-Ching Chen, and Giri Narasimhan. Automatic construction of 3-d building model from airborne lidar data through 2-d snake algorithm. IEEE Transactions on Geoscience and Remote Sensing, 53(1):3-14, 2015.
[44] Keqi Zhang, Jianhua Yan, and S-C Chen. Automatic construction of building footprints from airborne lidar data. IEEE Transactions on Geoscience and Remote Sensing, 44(9):2523-2533, 2006.
[45] Qian-Yi Zhou and Ulrich Neumann. Fast and extensible building modeling from airborne lidar data. In Proceedings of the 16th ACM SIGSPATIAL international conference on Advances in geographic information systems, page 7. ACM, 2008.
[46] Qian-Yi Zhou and Ulrich Neumann. 2.5 d building modeling by discovering global regularities. In 2012 IEEE Conference on Computer Vision and Pattern Recognition (CVPR), pages 326-333. IEEE, 2012.
[47] Jovisa Zunic and Paul L Rosin. Rectilinearity measurements for polygons. IEEE Transactions on Pattern Analysis and Machine Intelligence, 25(9): 1193-1200, 2003.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C#”) or in any other suitable programming language (e.g. “Go”, “Dart”, “Ada”, “Bash”, etc.). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for generating building contours from point cloud data, the method comprising:
a) identifying at least one building from said point cloud data;
b) determining contours of said at least one building from said point cloud data;
c) decomposing contours determined in step b);
d) regularizing said contours to result in regularized contours; and
e) generating final contours from said regularized contours.

2. The method according to claim 1, wherein step a) comprises identifying instance level building entities from said point cloud data.

3. The method according to claim 1, wherein step b) comprises using a topologically aware propagation method to trace initial contours of said at least one building.

4. The method according to claim 3, wherein step c) comprises consecutively decomposing said initial contours into multiple linear primitives using an energy formulation.

5. The method according to claim 1, wherein said contours are made more regular at a global level.

6. The method according to claim 3, wherein said initial contours are traced from corresponding undirected graphs.

7. The method according to claim 4, wherein said initial contours are decomposed by way of solving a multi-level energy minimization formulation.

8. The method according to claim 5, wherein said contours are made more regular by imposing at least one of: parallelism, homogeneity, orthogonality, and collinearity.

9. The method according to claim 4, wherein said linear primitives are regularized in step d) and resulting regularized linear primitives are assembled to form final contours that are watertight and manifold contours.

10. The method according to claim 1, wherein step a) comprises assigning a semantic label to each point in said point cloud and clustering points with similar labels into building entities.

11. The method according to claim 1, wherein said final contours are used in visualizing building models of said at least one building.

12. The method according to claim 3, wherein said topologically aware propagation method comprises the steps of:
aa) organizing alpha-shape segments into an undirected graph;
ab) selecting an arbitrary vertex with degree greater than 1 from said undirected graph as a beginning propagation point;
ac) if a current point has degree 2, selecting an unvisited point that is connected to said current point as a next point and if said current point has a degree greater than 2, basing said next point on a least azimuth angle;
ad) recursively repeating steps ab)-ac) until a close ring covering a maximum area has been obtained;
ae) repeating steps ab)-ad) until all inner closed rings have been extracted; and
at) distinguishing whether said inner closed rings are exact inner contours of said at least one building.

13. The method according to claim 4, wherein a random sample consensus (RANSAC) method is used to extract said multiple linear primitives.

14. Computer readable media having encoded thereon computer readable and computer executable instructions that, when executed, implements a method for generating building contours from point cloud data, the method comprising:
a) identifying at least one building from said point cloud data;
b) determining contours of said at least one building from said point cloud data;
c) decomposing contours determined in step b);
d) regularizing said contours to result in regularized contours; and
e) generating final contours from said regularized contours.

15. A system for generating building contours from point cloud data, the system comprising:
a building identification module for identifying at least one building from said point cloud data;
a contour determination module for determining contours of said at least one building from said point cloud data;
a contour decomposition module for decomposing contours determined by said contour determination module;
a contour regularization module for regularizing said contours to result in regularized contours; and
a contour generation module for generating final contours from said regularized contours.

16. The system according to claim 15, wherein said contour determination module uses a topologically aware propagation method to trace initial contours of said at least one building.

17. The system according to claim 16, wherein said contour determination module consecutively decomposes said initial contours into multiple linear primitives using an energy formulation.

18. The system according to claim 16, wherein said initial contours are traced from corresponding undirected graphs.

19. The system according to claim 17, wherein said initial contours are decomposed by way of solving a multi-level energy minimization formulation.

20. The system according to claim 17, wherein said building identification module assigns a semantic label to each point in said point cloud and clusters points with similar labels into building entities.
